(19) United States
(12) Patent Application Publication
(10) Pub. No.: US 2025/0358502 A1
(43) Pub. Date: Nov. 20, 2025

(54) OPTICAL IMAGING SYSTEM

(71) Applicant: Samsung Electro-Mechanics Co., Ltd., Suwon-si (KR)

(72) Inventors: Dong Hyuk JANG, Suwon-si (KR); Chang Min LEE, Suwon-si (KR); Yong Joo JO, Suwon-si (KR)

(73) Assignee: Samsung Electro-Mechanics Co., Ltd., Suwon-si (KR)

(21) Appl. No.: 19/033,867

(22) Filed: Jan. 22, 2025

(30) Foreign Application Priority Data
May 16, 2024 (KR) 10-2024-0064106

(51) Int. Cl. H04N 23/55

(52) U.S. Cl. CPC H04N 23/55

(57) ABSTRACT

An optical imaging system includes a first lens, a second lens, a third lens, a fourth lens, and a fifth lens disposed in order from an object side, wherein a conditional expression TTL/(2*IMG HT)≤0.57 is satisfied, where TTL is a distance along an optical axis from an object-side surface of the first lens to an image plane, and IMG HT is half a diagonal length of the image plane.

### CROSS-REFERENCE TO RELATED APPLICATIONS

This application claims the benefit under 35 USC 119 (a) of Korean Patent Application No. 10-2024-0064106 filed on May 16, 2024, in the Korean Intellectual Property Office, the entire disclosure of which is incorporated herein by reference for all purposes.

### BACKGROUND

### 1. Field

The present disclosure relates to an optical imaging system including five lenses.

### 2. Description of the Background

A high-resolution camera may be adopted in portable electronic devices, and high resolution for a rear camera and also for a front camera.

As resolution of a camera increases, a total optical length of a lens may increase, but due to slimming of a portable electronic device, it may be an objective to produce a camera having high resolution and a short total optical length.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens, a second lens, a third lens, a fourth lens, and a fifth lens disposed in order from an object side, wherein a conditional expression TTL/(2*IMG HT)≤0.57 is satisfied, where TTL is a distance along an optical axis from an object-side surface of the first lens to an image plane, and IMG HT is half a diagonal length of the image plane.

A conditional expression-0.1<f1/f3<1.0 may be satisfied, where f1 is a focal length of the first lens, and f3 is a focal length of the third lens.

A conditional expression-0.6<f1/f2<0 may be satisfied, where f1 is a focal length of the first lens, and f2 is a focal length of the second lens.

An object-side surface of the second lens may be concave.

A conditional expression 0<v1-v4<45 may be satisfied, where v1 is an Abbe number of the first lens, and v4 is an Abbe number of the fourth lens.

A conditional expression 70°<FOV* (2*IMG HT)/f may be satisfied, where FOV is a field of view of the optical imaging system, and f is a focal length of the optical imaging system.

An object-side surface of the fourth lens may be convex.

An image-side surface of the third lens may be convex.

A conditional expression Fno* {TTL/(2*IMG HT)}≤1.4 may be satisfied.

In another general aspect, an optical imaging system includes a first lens having positive refractive power, a second lens having negative refractive power, a third lens having refractive power, a fourth lens having refractive power, and a fifth lens having negative refractive power, wherein the first lens to the fifth lens are disposed in order from an object side, wherein a conditional expression-0.1<f1/f3<1.0 is satisfied, and where f1 is a focal length of the first lens, and f3 is a focal length of the third lens.

An image-side surface of the first lens may be concave, and a conditional expression D1/f<0.1 may be satisfied, where D1 is a distance between an image-side surface of the first lens and an object-side surface of the second lens, and f is a focal length of the optical imaging system.

A conditional expression 80°≤FOV may be satisfied, where FOV is a field of view of the optical imaging system.

A conditional expression TTL/(2*IMG HT)≤0.57 may be satisfied, where TTL is a distance from an object-side surface of the first lens to an image plane on an optical axis, and IMG HT is half a diagonal length of the image plane.

The third lens may have negative refractive power and a concave object-side surface.

A conditional expression 3<|f4/f| may be satisfied, where f4 is a focal length of the fourth lens, and f is a focal length of the optical imaging system.

Other features and aspects will be apparent from the following detailed description, the drawings, and the claims.

### BRIEF DESCRIPTION OF DRAWINGS

FIG. 1A is a configuration diagram illustrating an optical imaging system according to a first embodiment of the present disclosure.

FIG. 1B is a graph indicating aberration properties of an optical imaging system according to the first embodiment of the present disclosure.

FIG. 2A is a configuration diagram illustrating an optical imaging system according to a second embodiment of the present disclosure.

FIG. 2B is a graph indicating aberration properties of an optical imaging system according to the second embodiment of the present disclosure.

FIG. 3A is a configuration diagram illustrating an optical imaging system according to a third embodiment of the present disclosure.

FIG. 3B is a graph indicating aberration properties of an optical imaging system according to the third embodiment of the present disclosure.

FIG. 4A is a configuration diagram illustrating an optical imaging system according to a fourth embodiment of the present disclosure.

FIG. 4B is a graph indicating aberration properties of an optical imaging system according to the fourth embodiment of the present disclosure.

FIG. 5A is a configuration diagram illustrating an optical imaging system according to a fifth embodiment of the present disclosure.

FIG. 5B is a graph indicating aberration properties of an optical imaging system according to the fifth embodiment of the present disclosure.

FIG. 6A is a configuration diagram illustrating an optical imaging system according to a sixth embodiment of the present disclosure.

FIG. 6B is a graph indicating aberration properties of an optical imaging system according to the sixth embodiment of the present disclosure.

FIG. 7A is a configuration diagram illustrating an optical imaging system according to a seventh embodiment of the present disclosure.

FIG. 7B is a graph indicating aberration properties of an optical imaging system according to the seventh embodiment of the present disclosure.

FIG. 8A is a configuration diagram illustrating an optical imaging system according to an eighth embodiment of the present disclosure.

FIG. 8B is a graph indicating aberration properties of an optical imaging system according to the eighth embodiment of the present disclosure.

FIG. 9A is a configuration diagram illustrating an optical imaging system according to a ninth embodiment of the present disclosure.

FIG. 9B is a graph indicating aberration properties of an optical imaging system according to the ninth embodiment of the present disclosure.

FIG. 10A is a configuration diagram illustrating an optical imaging system according to a tenth embodiment of the present disclosure.

FIG. 10B is a graph indicating aberration properties of an optical imaging system according to the tenth embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure may provide an optical imaging system having a slim size.

In embodiments, a unit of values of radius of curvature, thickness, distance, focal length, IMG HT (1/2 of a diagonal length of an image plane), and semi-aperture of a lens may be millimeter (mm), and a unit of a field of view (FOV) may be degree) (°. Also, a thickness of a lens and a distance between lenses may refer to a thickness and a distance on an optical axis.

In the embodiments, an object side may indicate a direction in which an object is disposed, and an image side may indicate, for example, a direction in which an image plane is disposed on which an image is formed, or a direction in which an image sensor is disposed.

In the description of the shape of a lens in the embodiments, the configuration in which one surface is convex may indicate that a paraxial region portion of a surface may be convex, and the configuration in which one surface is concave may indicate that a paraxial region portion of the surface may be concave. A paraxial region of a lens surface is a central portion of the lens surface surrounding and including the optical axis of the lens surface in which light rays incident to the lens surface make a small angle θ to the optical axis, and the approximations sin 0 ˜ 0, tan 0 ˜ 0, and cos 0 ˜ 1 are valid. Accordingly, even when one surface of a lens is described as convex, an edge portion of the lens may be concave. Similarly, even when one surface of a lens is described as concave, an edge portion of the lens may be convex.

An optical imaging system according to embodiments may be employed in a camera of a mobile device. An optical imaging system according to embodiments may be a camera mounted on a front surface of a mobile device. The mobile device may be implemented as any type of portable electronic device such as a mobile communication terminal, a smartphone, a tablet PC, or the like.

In embodiments, the optical imaging system may include five lenses. In embodiments, the optical imaging system may include a first lens, a second lens, a third lens, a fourth lens and a fifth lens disposed in order from an object side.

Also, the optical imaging system may not only include five lenses, but may further include an image sensor configured to convert incident light into an electrical signal, an infrared blocking filter configured to block light in an infrared region incident on the image sensor, and a stop configured to adjust the amount of light incident on the lens.

In embodiments, the optical imaging system may include a lens formed of a plastic material. In embodiments, at least one of the first to fifth lenses may be formed of a plastic material, and preferably, the entirety of the first to fifth lenses may be formed of a plastic material.

In embodiments, the optical imaging system may include an aspherical lens. In embodiments, at least one of the first to fifth lenses may be configured as an aspherical lens, for example, two of the first to fifth lenses may be configured as aspherical lenses, for another example, all of the first to fifth lenses may be aspherical lenses. At least one surface of an object-side surface and an image-side surface of the one or more aspherical lens of the first to fifth lenses may be aspherical. For example, an object-side surface of any of the one or more aspherical lens of the first to fifth lenses may be aspherical, an image-side surface of any of the one or more aspherical lens of the first to fifth lenses may be aspherical, or both an object-side surface and an image-side surface of any of the one or more aspherical lens of the first to fifth lenses may be aspherical. The aspherical surface of the lens may be represented by Equation 1.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{20} + {MY}^{20} + {NY}^{20} + {OY}^{20} + {PY}^{20} + \qquad [ Equation 1 ]$$

In Equation 1, c is the reciprocal of the radius of curvature of the lens, K is the conic constant, and Y may indicate the distance from any point on the aspherical surface of the lens to the optical axis. Also, constants A-H, J, and L-P are aspherical constants from the 4th to the 30th orders in order, and Z (or SAG) is the distance in the optical axis direction between any point on the aspherical surface and an apex of the aspherical surface.

In embodiments, the optical imaging system may satisfy conditional expressions as below.

$$TTL / 2 * IMG \leq 0.57 \qquad [ Conditional expression 1 ]$$

$$Fno * \{ TTL / ( 2 * IMG HT ) \} \leq 1.4 \qquad [ Conditional expression 2 ]$$

$$80 ° \leq F O V \qquad [ Conditional expression 3 ]$$

$$- 0.6 < f 1 / f 2 < 0 \qquad [ Conditional expression 4 ]$$

$$- 0.1 < f 1 / f 3 < 1. \qquad [ Conditional expression 5 ]$$

$$0 < v 1 - v 4 < 45 \qquad [ Conditional expression 6 ]$$

In [Conditional expression 1], TTL is the distance on the optical axis from an object-side surface of the first lens to an image plane, and IMG HT is half the diagonal length of the image plane (i.e., 2*IMG HT is the diagonal length of the image plane). [Conditional expression 1] may be related to the configuration in which the optical imaging system according to embodiments may have a reduced thickness.

[Conditional expression 2] is the product of [Conditional expression 1] and Fno (F-number of the optical imaging system), and [Conditional expression 2] may be related to the configuration in which the optical imaging system according to embodiments has an appropriate level of brightness performance (for the front camera) and may have a reduced thickness.

In [Conditional expression 3], FOV is the maximum field of view of the optical imaging system, and [Conditional expression 3] may be related to the configuration in which the optical imaging system according to embodiments may have an appropriate field of view range (for the front camera).

In [Conditional expression 4], f1 is a focal length of the first lens, and f2 is a focal length of the second lens. By designing the focal lengths of the first lens and the second lens to satisfy the range of [Conditional expression 4], the optical imaging system according to embodiments may assure aberration correction performance.

In [Conditional expression 5], f1 is a focal length of the first lens, and f3 is a focal length of the third lens. By designing the focal lengths of the first lens and the third lens to satisfy the range of [Conditional expression 5], the optical imaging system according to embodiments may assure aberration correction performance.

In [Conditional expression 6], v1 is an Abbe number of the first lens, and v4 is an Abbe number of the fourth lens. When the first lens and the fourth lens satisfy [Conditional expression 6], the chromatic aberration of the optical imaging system according to embodiments may be reduced.

In embodiments, the optical imaging system may further satisfy conditional expressions as below.

$$TTL / f < 1.35 \qquad [ Conditional expression 7 ]$$

$$D 1 / f < 0. 1 \qquad [ Conditional expression 8 ]$$

$$25 < v 1 - v 2 < 45 \qquad [ Conditional expression 9 ]$$

$$0 < f 1 / f < 1.4 \qquad [ Conditional expression 10 ]$$

$$- 10 < f 2 / f < - 1 \qquad [ Conditional expression 11 ]$$

$$5 < \vert f 3 / f \vert \qquad [ Conditional expression 12 ]$$

$$3 < \vert f 4 / f \vert \qquad [ Conditional expression 13 ]$$

$$- 30 < f 5 / f < 0 \qquad [ Conditional expression 14 ]$$

$$70 ° < F O V * ( 2 * IMG HT ) / f \qquad [ Conditional expression 15 ]$$

$$0.26 < ET 1 / SD 1 < 0.30 \qquad [ Conditional expression 16 ]$$

$$0.22 < SD 4 / SD 10 < 0.27 \qquad [ Conditional expression 17 ]$$

$$CT 2 < 0.19 \qquad [ Conditional expression 18 ]$$

In [Conditional expression 7], TTL is a distance on an optical axis from an object-side surface of the first lens to the image plane, in [Conditional expression 8], D1 is a distance between an image-side surface of the first lens and an object-side surface of the second lens, and in [Conditional expression 7] and [Conditional expression 8], f is a focal length of the optical imaging system. [Conditional expression 7] and [Conditional expression 8] may be related to miniaturization of the optical imaging system according to embodiments.

In [Conditional expression 9], v1 is an Abbe number of the first lens, and v2 is an Abbe number of the second lens. [Conditional expression 9] may be related to the color aberration correction performance of the optical imaging system according to embodiments.

In [Conditional expression 10], f1 is a focal length of the first lens, in [Conditional expression 11], f2 is a focal length of the second lens, in [Conditional expression 12], f3 is a focal length of the third lens, in [Conditional expression 13], f4 is a focal length of the fourth lens, in [Conditional expression 14], f5 is a focal length of the fifth lens, and in [Conditional expression 10] to [Conditional expression 14], f is a focal length of the optical imaging system. [Conditional expression 10] to [Conditional expression 14] may be related to aberration correction performance of the optical imaging system according to embodiments.

In [Conditional expression 15], FOV is the maximum field of view of the optical imaging system, IMG HT is half of the diagonal length of the image plane (i.e., 2*IMG HT is the diagonal length of the image plane), and f is a focal length of the optical imaging system. [Conditional expression 15] may be related to a feature of the optical imaging system having a reduced thickness and an appropriate range of field of view (for the front camera) according to embodiments.

In [Conditional expression 16], ET1 is the thickness of the edge portion of the first lens, and SD1 is the semi-aperture of an object-side surface of the first lens. [Conditional expression 16] may be related to an aberration correction performance of the optical imaging system according to embodiments.

In [Conditional expression 17], SD4 is a semi-aperture of an image-side surface of the second lens, SD10 is a semi-aperture of an image-side surface of the fifth lens, and CT2 in [Conditional expression 18] is a central thickness (thickness on the optical axis) of the second lens. [Conditional expression 17] and [Conditional expression 18] may be related to shape conditions of the second lens to assure resolution of the optical imaging system according to embodiments.

Hereinafter, the optical imaging system according to embodiments may be described with reference to the attached drawings.

### First Embodiment

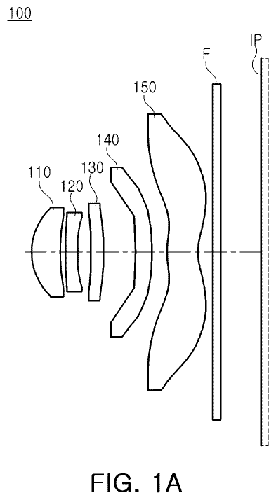

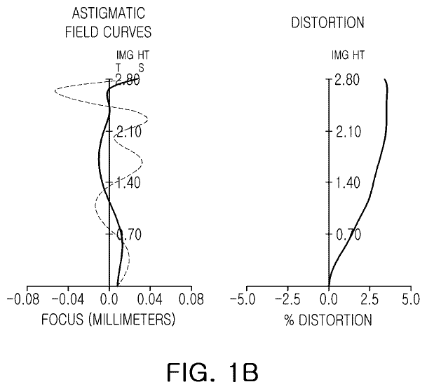

FIG. 1A is a configuration diagram illustrating an optical imaging system according to a first embodiment. FIG. 1B is a graph indicating aberration properties of an optical imaging system according to the first embodiment.

According to the first embodiment, an optical imaging system 100 may include a first lens 110, a second lens 120, a third lens 130, a fourth lens 140, and a fifth lens 150 disposed in order from an object side, and may further include an infrared blocking filter F and an image sensor IP disposed on an image side of the fifth lens 150.

Also, although not illustrated in the drawing, a stop may be disposed between an object-side surface and an image-side surface of the first lens 110, and a spacer may be disposed between the second lens 120 and the third lens 130.

The first lens 110 may have positive refractive power. A focal length of the first lens 110 may be 2.0 mm or more. An object-side surface of the first lens 110 may be convex in a paraxial region, and an image-side surface of the first lens 110 may be concave in a paraxial region. The first lens 110 may be formed of a plastic material. An Abbe number of the first lens 110 may be 50 or more. The first lens 110 may be configured as an aspherical lens. For example, the object-side surface and the image-side surface of the first lens 110 may be aspherical.

The second lens 120 may have negative refractive power. A focal length of the second lens 120 may be −6.0 mm or less. An object-side surface of the second lens 120 may be convex in a paraxial region, and an image-side surface of the second lens 120 may be concave in a paraxial region. The second lens 120 may be formed of a plastic material. For example, the second lens 120 may be formed of a plastic material having optical properties (refractive index and Abbe number) different from those of the first lens 110. An Abbe number of the second lens 120 may be less than 20. The second lens 120 may be configured as an aspherical lens. For example, an object-side surface and an image-side surface of the second lens 120 may be aspherical.

The third lens 130 may have positive refractive power. A focal length of the third lens 130 may be 18.0 mm or more. An object-side surface of the third lens 130 may be convex in a paraxial region, and an image-side surface of the third lens 130 may be concave in a paraxial region. The third lens 130 may be formed of a plastic material. For example, the third lens 130 may be formed of a plastic material having the same optical properties (refractive index and Abbe number) as those of the second lens 120. An Abbe number of the third lens 130 may be less than 20. The third lens 130 may be configured as an aspherical lens. For example, an object-side surface and an image-side surface of the third lens 130 may be aspherical.

The fourth lens 140 may have positive refractive power. A focal length of the fourth lens 140 may be 10.0 mm or more. An object-side surface of the fourth lens 140 may be concave in a paraxial region, and an image-side surface of the fourth lens 140 may be convex in a paraxial region. The fourth lens 140 may be formed of a plastic material. For example, the fourth lens 140 may be formed of a plastic material having optical properties (refractive index and Abbe number) different from those of the third lens 130. An Abbe number of the fourth lens 140 may be 10 or more, and may be less than an Abbe number of the first lens 110. The fourth lens 140 may be configured as an aspherical lens. For example, an object-side surface and an image-side surface of the fourth lens 140 may be aspherical.

The fifth lens 150 may have negative refractive power. A focal length of the fifth lens 150 may be less than-1.0 mm. An object-side surface of the fifth lens 150 may be convex, and an image-side surface of the fifth lens 150 may be concave. The fifth lens 150 may be formed of a plastic material. For example, the fifth lens 150 may be formed of a plastic material having optical properties (refractive index and Abbe number) different from those of the fourth lens 140. An Abbe number of the fifth lens 150 may be 50 or more. The fifth lens 150 may be configured as an aspherical lens. For example, an object-side surface and an image-side surface of the fifth lens 150 may be aspherical.

A focal length of the optical imaging system 100 according to the first embodiment may be 2.937 mm, a Fno may be 2.290, a FOV may be 85.480°, and a TTL may be 3.131 mm.

Table 1 below lists optical and physical parameters of the optical imaging system 100 according to the first embodiment.

TABLE 1

| | Radius of | Thickness/ | Refractive | Abbe | Focal | Effective |
|---|---|---|---|---|---|---|
| Surface | Curvature | Distance | Index | number | length | Radius |
| Object | Infinity | Infinity | | | | |
| 1 | Infinity | −0.259 | | | | |
| 2 | 0.916 | 0.393 | 1.544 | 56.00 | 2.342 | 0.630 |
| 3 | 2.739 | 0.072 | | | | 0.588 |
| 4 | 13.451 | 0.162 | 1.671 | 19.40 | −6.430 | 0.567 |
| 5 | 3.280 | 0.093 | | | | 0.504 |
| 6 | Infinity | 0.090 | | | | |
| 7 | 13.742 | 0.173 | 1.671 | 19.40 | 33.522 | 0.581 |
| 8 | 34.513 | 0.435 | | | | 0.699 |
| 9 | −32.519 | 0.223 | 1.567 | 37.40 | 41.126 | 1.020 |
| 10 | −13.666 | 0.211 | | | | 1.222 |
| 11 | 1.398 | 0.423 | 1.535 | 55.70 | −7.601 | 1.866 |
| 12 | 0.931 | 0.193 | | | | 1.994 |
| 13 | Infinity | 0.110 | 1.517 | 64.20 | | |
| 14 | Infinity | 0.552 | | | | |
| Image | Infinity | | | | | |

Table 2 below lists aspherical data of the optical imaging system 100 according to the first embodiment.

TABLE 2

| Surface | 2 | 3 | 4 | 5 | 7 |
|---|---|---|---|---|---|
| K | −7.14E−02 | 1.32E+01 | 0.00E+00 | −1.06E+01 | 0.00E+00 |
| A | −1.72E−02 | −4.57E−01 | −1.95E−01 | −2.01E−01 | 9.47E−02 |
| B | −1.96E+00 | 1.67E+01 | −6.89E−01 | 2.41E+01 | −3.82E+01 |
| C | 1.03E+02 | −6.80E+02 | 1.56E+02 | −1.17E+03 | 1.49E+03 |
| D | −2.17E+03 | 1.59E+04 | −6.34E+03 | 3.81E+04 | −3.64E+04 |
| E | 2.57E+04 | −2.39E+05 | 1.49E+05 | −8.26E+05 | 5.95E+05 |
| F | −1.86E+05 | 2.43E+06 | −2.23E+06 | 1.24E+07 | −6.75E+06 |
| G | 8.09E+05 | −1.75E+07 | 2.24E+07 | −1.32E+08 | 5.43E+07 |
| H | −1.74E+06 | 8.97E+07 | −1.56E+08 | 1.01E+09 | −3.15E+08 |
| J | −1.23E+06 | −3.31E+08 | 7.67E+08 | −5.58E+09 | 1.32E+09 |
| L | 1.99E+07 | 8.69E+08 | −2.65E+09 | 2.19E+10 | −3.93E+09 |
| M | −6.06E+07 | −1.58E+09 | 6.30E+09 | −5.97E+10 | 8.19E+09 |
| N | 9.53E+07 | 1.88E+09 | −9.83E+09 | 1.07E+11 | −1.13E+10 |
| O | −7.95E+07 | −1.32E+09 | 9.05E+09 | −1.15E+11 | 9.27E+09 |
| P | 2.79E+07 | 4.12E+08 | −3.72E+09 | 5.50E+10 | −3.42E+09 |
| Surface | 8 | 9 | 10 | 11 | 12 |
| K | 0.00E+00 | 0.00E+00 | 1.16E+01 | −1.02E+00 | −2.83E+00 |
| A | −3.65E−01 | −4.04E−01 | −1.17E+00 | −1.97E+00 | −1.06E+00 |
| B | 2.69E−01 | 3.61E+00 | 6.67E+00 | 4.83E+00 | 2.41E+00 |
| C | −3.28E+01 | −3.32E+01 | −3.20E+01 | −1.07E+01 | −4351E+00 |
| D | 9.29E+02 | 2.46E+02 | 1.34E+02 | 1.90E+01 | 6.58E+00 |
| E | −1.39E+04 | −1.38E+03 | −4.45E+02 | −2.40E+01 | −7.43E+00 |
| F | 1.30E+05 | 5.65E+03 | 1.10E+03 | 2.16E+01 | 6.50E+00 |
| G | −8.29E+05 | −1.68E+04 | −1.95E+03 | −1.39E+01 | −4.38E+00 |
| H | 3.68E+06 | 3.65E+04 | 2.48E+03 | 6.46E+00 | 2.25E+00 |
| J | −1.16E+07 | −5.81E+04 | −2.24E+03 | −2.19E+00 | −8.67E−01 |
| L | 2.56E+07 | 6.65E+04 | 1.42E+03 | 5.31E−01 | 2.45E−01 |
| M | −3.91E+07 | −5.31E+04 | −6.14E+02 | −9.00E−02 | −4.87E−02 |
| N | 3.91E+07 | 2.79E+04 | 1.72E+02 | 1.01E−02 | 6.48E−03 |
| O | −2.31E+07 | −8.61E+03 | −2.80E+01 | −6.68E−04 | −5.14E−04 |
| P | −3.42E+09 | 1.18E+03 | 2.00E+00 | 1.97E−05 | 1.84E−05 |

### Second Embodiment

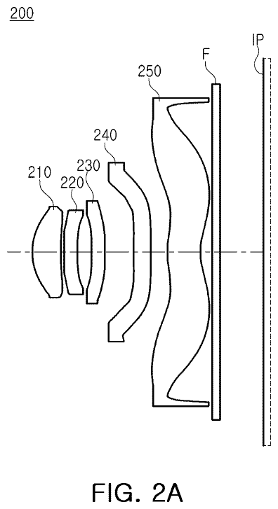

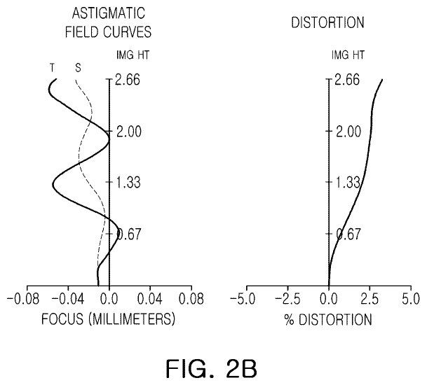

FIG. 2A is a configuration diagram illustrating an optical imaging system according to a second embodiment. FIG. 2B is a graph indicating aberration properties of an optical imaging system according to the second embodiment.

According to the second embodiment, an optical imaging system 200 may include a first lens 210, a second lens 220, a third lens 230, a fourth lens 240, and a fifth lens 250 disposed in order from an object side, and may further include an infrared blocking filter F and an image sensor IP disposed on an image side of the fifth lens 250.

Also, although not illustrated in the drawings, a stop may be disposed on an object side of the first lens 210, and a spacer may be disposed between the second lens 220 and the third lens 230.

The first lens 210 may have positive refractive power. A focal length of the first lens 210 may be 2.0 mm or more. An object-side surface of the first lens 210 may be convex in a paraxial region, and an image-side surface of the first lens 210 may be concave in a paraxial region. The first lens 210 may be formed of a plastic material. An Abbe number of the first lens 210 may be 50 or more. The first lens 210 may be configured as an aspherical lens. For example, an object-side surface and an image-side surface of the first lens 210 may be aspherical.

The second lens 220 may have negative refractive power. A focal length of the second lens 220 may be −6.0 mm or less. An object-side surface of the second lens 220 may be convex in a paraxial region, and an image-side surface of the second lens 220 may be concave in a paraxial region. The second lens 220 may be formed of a plastic material. For example, the second lens 220 may be formed of a plastic material having optical properties (refractive index and Abbe number) different from those of the first lens 210. An Abbe number of the second lens 220 may be less than 20. The second lens 220 may be configured as an aspherical lens. For example, an object-side surface and an image-side surface of the second lens 220 may be aspherical.

The third lens 230 may have negative refractive power. A focal length of the third lens 230 may be −40.0 mm or less. An object-side surface of the third lens 230 may be concave in a paraxial region, and an image-side surface of the third lens 230 may be convex in a paraxial region. The third lens 230 may be formed of a plastic material. For example, the third lens 230 may be formed of a plastic material having the same optical properties (refractive index and Abbe number) as those of the second lens 220. An Abbe number of the third lens 230 may be less than 20. The third lens 230 may be configured as an aspherical lens. For example, an object-side surface and an image-side surface of the third lens 230 may be aspherical.

The fourth lens 240 may have negative refractive power. A focal length of the fourth lens 240 may be −10.0 mm or less. An object-side surface of the fourth lens 240 may be convex in a paraxial region, and an image-side surface of the fourth lens 240 may be concave in a paraxial region. The fourth lens 240 may be formed of a plastic material. For example, the fourth lens 240 may be formed of a plastic material having optical properties (refractive index and Abbe number) different from those of the third lens 230. An Abbe number of the fourth lens 240 may be 10 or more, and may be less than an Abbe number of the first lens 210. The fourth lens 240 may be configured as an aspherical lens. For example, an object-side surface and an image-side surface of the fourth lens 240 may be aspherical.

The fifth lens 250 may have negative refractive power. A focal length of the fifth lens 250 may be less than-1.0 mm. An object-side surface of the fifth lens 250 may be convex, and an image-side surface of the fifth lens 250 may be concave. The fifth lens 250 may be formed of a plastic material. For example, the fifth lens 250 may be formed of a plastic material having optical properties (refractive index and Abbe number) different from those of the fourth lens 240. An Abbe number of the fifth lens 250 may be 50 or more. The fifth lens 250 may be configured as an aspherical lens. For example, an object-side surface and an image-side surface of the fifth lens 250 may be aspherical.

A focal length of the optical imaging system 200 according to the second embodiment may be 2.898 mm, a Fno may be 2.300, a FOV may be 85.897°, and a TTL may be 3.150 mm.

Table 3 below lists optical and physical parameters of the optical imaging system 200 according to the second embodiment.

TABLE 3

| | Radius of | Thickness/ | Refractive | Abbe | Focal | Effective |
|---|---|---|---|---|---|---|
| Surface | Curvature | Distance | Index | number | length | Radius |
| Object | Infinity | Infinity | | | | |
| 1 | Infinity | 0.000 | | | | |
| 2 | 0.909 | 0.387 | 1.544 | 56.00 | 2.176 | 0.630 |
| 3 | 3.272 | 0.043 | | | | 0.594 |
| 4 | 13.713 | 0.180 | 1.671 | 19.40 | −6.927 | 0.570 |
| 5 | 3.483 | 0.095 | | | | 0.492 |
| 6 | Infinity | 0.100 | | | | |
| 7 | −6.878 | 0.180 | 1.671 | 19.40 | −41.515 | 0.555 |
| 8 | −9.195 | 0.394 | | | | 0.685 |
| 9 | 9.673 | 0.230 | 1.651 | 21.50 | −15.352 | 1.019 |
| 10 | 4.893 | 0.227 | | | | 1.235 |
| 11 | 1.133 | 0.454 | 1.535 | 55.70 | −74.316 | 1.939 |
| 12 | 0.947 | 0.159 | | | | 2.052 |
| 13 | Infinity | 0.110 | 1.517 | 64.20 | | |
| 14 | Infinity | 0.590 | | | | |
| Image | Infinity | | | | | |

Table 4 below lists aspherical data of the optical imaging system 200 according to the second embodiment.

TABLE 4

| Surface | 2 | 3 | 4 | 5 | 7 |
|---|---|---|---|---|---|
| K | −2.77E−01 | 7.21E+00 | 3.39E+01 | 1.08E+01 | −8.75E+00 |
| A | −3.32E−02 | −3.60E−01 | −6.80E−02 | 5.42E−01 | −4.15E−01 |
| B | −1.44E+00 | 1.02E+00 | −9.93E−01 | −3.13E+01 | −1.32E+00 |
| C | 9.56E+01 | −3.17E−+01 | 4.11E+01 | 1.48E+03 | −5.34E+01 |
| D | −2.06E+03 | 4.32E+02 | −4.63E+02 | −4.02E+04 | 2.50E+03 |
| E | 2.48E+04 | −1.93E+03 | 3.21E+03 | 7.03E+05 | −4.89E+04 |
| F | −1.91E+05 | −1.46E+04 | −1.38E+04 | −8.28E+06 | 5.69E+05 |
| G | 9.79E+05 | 2.54E+05 | 3.59E+04 | 6.69E+07 | −4.32E+06 |
| H | −3.41E+06 | −1.63E+06 | −5.16E+04 | −3.73E+08 | 2.19E+07 |
| J | 7.96E+06 | 5.86E+06 | 3.14E+04 | 1.40E+09 | −7.36E+07 |
| L | −1.19E+07 | −1.24E+07 | 0.00E+00 | −3.42E+09 | 1.58E+08 |
| M | 1.04E+07 | 1.45E+07 | 0.00E+00 | 4.86E+09 | −1.96E+08 |
| N | −4.01E+06 | −7.27E+06 | 0.00E+00 | −3.06E+09 | 1.07E+08 |
| O | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 |

| Surface | 8 | 9 | 10 | 11 | 12 |
|---|---|---|---|---|---|
| K | 0.00E+00 | 0.00E+00 | 6.49E+00 | −1.44E+00 | −2.47E+00 |
| A | −4.74E−01 | −4.99E−01 | −1.31E+00 | −1.65E+00 | −9.01E−01 |
| B | 8.73E−01 | 2.42E+00 | 6.88E+00 | 3.35E+00 | 1.66E+00 |
| C | −7.48E+00 | −1.01E+01 | −2.85E+01 | −5.28E+00 | −2.42E+00 |
| D | 3.91E+01 | 2.56E+01 | 9.13E+01 | 6.18E+00 | 2.68E+00 |
| E | −1.23E+02 | −5.96E+01 | −2.30E+02 | −5.15E+00 | −2.22E+00 |
| F | 2.41E+02 | 1.37E+02 | 4.39E+02 | 3.05E+00 | 1.35E+00 |
| G | −2.55E+02 | −2.45E+02 | −6.12E+02 | −1.29E+00 | −6.02E−01 |
| H | 1.12E+02 | 2.74E+02 | 6.03E+02 | 3.84E−01 | 1.91E−01 |
| J | 0.00E+00 | −1.62E+02 | −4.05E+02 | −7.97E−02 | −4.19E−02 |
| L | 0.00E+00 | 3.87E+01 | 1.75E+02 | 1.09E−02 | 6.03E−03 |
| M | 0.00E+00 | 0.00E+00 | −4.39E+01 | −8.87E−04 | −5.10E−04 |
| N | 0.00E+00 | 0.00E+00 | 4.83E+00 | 3.25E−05 | 1.92E−05 |
| O | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 |

### Third Embodiment

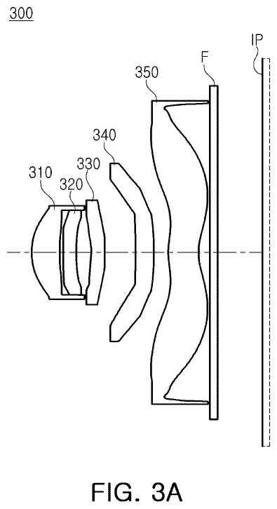

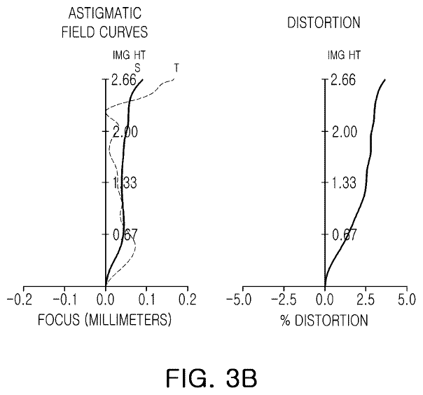

FIG. 3A is a configuration diagram illustrating an optical imaging system according to a third embodiment. FIG. 3B is a graph indicating aberration properties of an optical imaging system according to the third embodiment.

According to a third embodiment, an optical imaging system 300 may include a first lens 310, a second lens 320, a third lens 330, a fourth lens 340, and a fifth lens 350 disposed in order from an object side, and may further include an infrared blocking filter F and an image sensor IP disposed on an image side of the fifth lens 350.

Also, although not illustrated in the drawing, a stop may be disposed on an object side of the first lens 310, and a spacer may be disposed between the second lens 320 and the third lens 330.

The first lens 310 may have positive refractive power. A focal length of the first lens 310 may be 2.0 mm or more. An object-side surface of the first lens 310 may be convex in a paraxial region, and an image-side surface of the first lens 310 may be concave in a paraxial region. The first lens 310 may be formed of a plastic material. An Abbe number of the first lens 310 may be 50 or more. The first lens 310 may be configured as an aspherical lens. For example, an object-side surface and an image-side surface of the first lens 310 may be aspherical.

The second lens 320 may have negative refractive power. A focal length of the second lens 320 may be −6.0 mm or less. An object-side surface of the second lens 320 may be convex in a paraxial region, and an image-side surface of the second lens 320 may be concave in a paraxial region. The second lens 320 may be formed of a plastic material. For example, the second lens 320 may be formed of a plastic material having optical properties (refractive index and Abbe number) different from those of the first lens 310. An Abbe number of the second lens 320 may be less than 20. The second lens 320 may be configured as an aspherical lens. For example, an object-side surface and an image-side surface of the second lens 320 may be aspherical.

The third lens 330 may have negative refractive power. A focal length of the third lens 330 may be −40.0 mm or less. An object-side surface of the third lens 330 may be concave in a paraxial region, and an image-side surface of the third lens 330 may be convex in a paraxial region. The third lens 330 may be formed of a plastic material. For example, the third lens 330 may be formed of a plastic material having the same optical properties (refractive index and Abbe number) as those of the second lens 320. An Abbe number of the third lens 330 may be less than 20. The third lens 330 may be configured as an aspherical lens. For example, an object-side surface and an image-side surface of the third lens 330 may be aspherical.

The fourth lens 340 may have positive refractive power. A focal length of the fourth lens 340 may be 10.0 mm or more. An object-side surface of the fourth lens 340 may be concave in a paraxial region, and an image-side surface of the fourth lens 340 may be convex in a paraxial region. The fourth lens 340 may be formed of a plastic material. For example, the fourth lens 340 may be formed of a plastic material having optical properties (refractive index and Abbe number) different from those of the third lens 330. An Abbe number of the fourth lens 340 may be 10 or more, and may be smaller than an Abbe number of the first lens 310. The fourth lens 340 may be configured as an aspherical lens. For example, an object-side surface and an image-side surface of the fourth lens 340 may be aspherical.

The fifth lens 350 may have negative refractive power. A focal length of the fifth lens 350 may be less than-1.0 mm. An object-side surface of the fifth lens 350 may be convex, and an image-side surface of the fifth lens 350 may be concave. The fifth lens 350 may be formed of a plastic material. For example, the fifth lens 350 may be formed of a plastic material having optical properties (refractive index and Abbe number) different from those of the fourth lens 340. An Abbe number of the fifth lens 350 may be 50 or more. The fifth lens 350 may be configured as an aspherical lens. For example, an object-side surface and an image-side surface of the fifth lens 350 may be aspherical.

A focal length of the optical imaging system 300 according to the third embodiment may be 2.927 mm, a Fno may be 2.320, a FOV may be 85.480°, and a TTL may be 3.150 mm.

Table 5 below lists optical and physical parameters of the optical imaging system 300 according to the third embodiment.

TABLE 5

| | Radius of | Thickness/ | Refractive | Abbe | Focal | Effective |
|---|---|---|---|---|---|---|
| Surface | Curvature | Distance | Index | number | length | Radius |
| Object | Infinity | Infinity | | | | |
| 1 | Infinity | 0.000 | | | | |
| 2 | 0.909 | 0.382 | 1.544 | 56.00 | 2.227 | 0.630 |
| 3 | 3.056 | 0.046 | | | | 0.594 |
| 4 | 12.104 | 0.180 | 1.671 | 19.40 | −6.558 | 0.571 |
| 5 | 3.236 | 0.104 | | | | 0.497 |
| 6 | Infinity | 0.100 | | | | |
| 7 | −35.281 | 0.180 | 1.671 | 19.40 | −53.137 | 0.559 |
| 8 | −1608.369 | 0.429 | | | | 0.707 |
| 9 | −92.567 | 0.250 | 1.567 | 37.40 | 35.903 | 1.059 |
| 10 | −16.794 | 0.195 | | | | 1.244 |
| 11 | 1.228 | 0.415 | 1.535 | 55.70 | −9.124 | 1.910 |
| 12 | 0.866 | 0.154 | | | | 2.048 |
| 13 | Infinity | 0.110 | 1.517 | 64.20 | | |
| 14 | Infinity | 0.605 | | | | |
| Image | Infinity | | | | | |

Table 6 below lists aspherical data of the optical imaging system 300 according to the third embodiment.

TABLE 6

| Surface | 2 | 3 | 4 | 5 | 7 |
|---|---|---|---|---|---|
| K | −2.57E−01 | 7.53E+00 | 7.69E+00 | −2.72E+00 | 1.90E+01 |
| A | −1.25E−01 | 7.60E−02 | 5.36E−01 | 1.79E−01 | −7.88E−01 |
| B | 8.39E+00 | −2.46E+01 | −4.90E+01 | −5.18E+01 | 1.09E+01 |
| C | −2.86E+02 | 6.33E+02 | 1.91E+03 | 4.58E+03 | −4.81 E+02 |
| D | 6.29E+03 | −8.05E+03 | −4.59E+04 | −2.00E+05 | 1.33E+04 |
| E | −9.30E+04 | 2.34E+04 | 7.37E+05 | 5.33E+06 | −2.44E+05 |
| F | 9.46E+05 | 8.22E+05 | −8.19E+06 | −9.46E+07 | 3.07E+06 |
| G | −6.77E+06 | −1.44E+07 | 6.46E+07 | 1.17E+09 | −2.71 E+07 |
| H | 3.43E+07 | 1.24E+08 | −3.65E+08 | −1.02E+10 | 1.68E+08 |
| J | −1.24E+08 | −6.73E+08 | 1.48E+09 | 6.40E+10 | −7.33E+08 |
| L | 3.14E+08 | 2.43E+09 | −4.27E+09 | −2.85E+11 | 2.20E+09 |
| M | −5.47E+08 | −5.89E+09 | 8.46E+09 | 8.80E+11 | −4.36E+09 |
| N | 6.19E+08 | 9.17E+09 | −1.09E+10 | −1.79E+12 | 5.23E+09 |
| O | −4.09E+08 | −8.33E+09 | 8.22E+09 | 2.17E+12 | −3.13E+09 |
| P | 1.19E+08 | 3.36E+09 | −2.70E+09 | −1.18E+12 | 4.66E+08 |
| Surface | 8 | 9 | 10 | 11 | 12 |
| K | 0.00E+00 | 0.00E+00 | −9.00E+01 | −1.22E+00 | −2.57E+00 |
| A | −2.87E−01 | −3.67E−01 | −1.17E+00 | −2.04E+00 | −1.15E+00 |
| B | −1.02E+01 | 2.90E+00 | 6.93E+00 | 5.58E+00 | 2.90E+00 |
| C | 2.79E+02 | −6.72E−01 | −2.40E+01 | −1.33E+01 | −5.99E+00 |
| D | −4.70E+03 | −2.00E+02 | 2.97E+01 | 2.43E+01 | 9.49E+00 |
| E | 5.26E+04 | 1.78E+03 | 1.18E+02 | −3.19E+01 | −1.13E+01 |
| F | −4.07E+05 | −8.30E+03 | −7.26E+02 | 3.04E+01 | 1.01E+01 |
| G | 2.24E+06 | 2.45E+04 | 1.96E+03 | −2.13E+01 | −6.68E+00 |
| H | −8.88E+06 | −4.84E+04 | −3.31E+03 | 1.11E+01 | 3.28E+00 |
| J | 2.54E+07 | 6.54E+04 | 3.81E+03 | −4.24E+00 | −1.18E+00 |
| L | −5.22E+07 | −6.01E+04 | −3.03E+03 | 1.18E+00 | 3.08E−01 |
| M | 7.47E+07 | 3.67E+04 | 1.64E+03 | −2.32E−01 | −5.61E−02 |
| N | −7.07E+07 | −1.40E+04 | −5.77E+02 | 3.04E−02 | 6.78E−03 |
| O | 3.99E+07 | 2.97E+03 | 1.19E+02 | −2.38E−03 | −4.88E−04 |
| P | −1.01E+07 | −2.55E+02 | −1.10E+01 | 8.48E−05 | 1.58E−05 |

### Fourth Embodiment

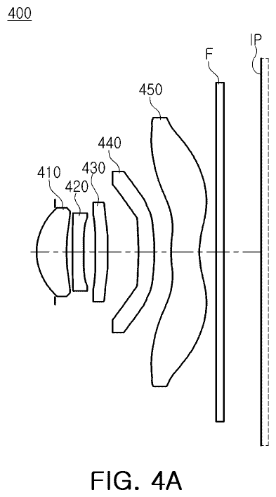

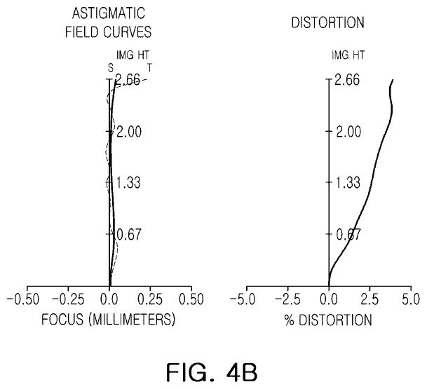

FIG. 4A is a configuration diagram illustrating an optical imaging system according to a fourth embodiment. FIG. 4B is a graph indicating aberration properties of an optical imaging system according to the fourth embodiment.

According to the fourth embodiment, an optical imaging system 400 may include a first lens 410, a second lens 420, a third lens 430, a fourth lens 440, and a fifth lens 450 disposed in order from an object side, and may further include an infrared blocking filter F and an image sensor IP disposed on an image side of the fifth lens 450.

Also, a stop may be disposed between an object-side surface and an image-side surface of the first lens 410, and a spacer may be disposed between the second lens 420 and the third lens 430.

The first lens 410 may have positive refractive power. A focal length of the first lens 410 may be 2.0 mm or more. An object-side surface of the first lens 410 may be convex in a paraxial region, and an image-side surface of the first lens 410 may be concave in a paraxial region. The first lens 410 may be formed of a plastic material. An Abbe number of the first lens 410 may be 50 or more. The first lens 410 may be configured as an aspherical lens. For example, an object-side surface and an image-side surface of the first lens 410 may be aspherical.

The second lens 420 may have negative refractive power. A focal length of the second lens 420 may be −6.0 mm or less. An object-side surface and an image-side surface of the second lens 420 may be concave in a paraxial region. The second lens 420 may be formed of a plastic material. For example, the second lens 420 may be formed of a plastic material having optical properties (refractive index and Abbe number) different from those of the first lens 410. An Abbe number of the second lens 420 may be less than 20. The second lens 420 may be configured as an aspherical lens. For example, an object-side surface and an image-side surface of the second lens 420 may be aspherical.

The third lens 430 may have positive refractive power. A focal length of the third lens 430 may be 18.0 mm or more. An object-side surface of the third lens 430 may be convex in a paraxial region, and an image-side surface of the third lens 430 may be concave in a paraxial region. The third lens 430 may be formed of a plastic material. For example, the third lens 430 may be formed of a plastic material having the same optical properties (refractive index and Abbe number) as those of the second lens 420. An Abbe number of the third lens 430 may be less than 20. The third lens 430 may be configured as an aspherical lens. For example, an object-side surface and an image-side surface of the third lens 430 may be aspherical.

The fourth lens 440 may have positive refractive power. A focal length of the fourth lens 440 may be 10.0 mm or more. An object-side surface of the fourth lens 440 may be concave in a paraxial region, and an image-side surface of the fourth lens 440 may be convex in a paraxial region. The fourth lens 440 may be formed of a plastic material. For example, the fourth lens 440 may be formed of a plastic material having optical properties (refractive index and Abbe number) different from those of the third lens 430. An Abbe number of the fourth lens 440 may be 10 or more, and may be smaller than an Abbe number of the first lens 410. The fourth lens 440 may be configured as an aspherical lens. For example, an object-side surface and an image-side surface of the fourth lens 440 may be aspherical.

The fifth lens 450 may have negative refractive power. A focal length of the fifth lens 450 may be less than-1.0 mm. An object-side surface of the fifth lens 450 may be convex, and an image-side surface of the fifth lens 450 may be concave. The fifth lens 450 may be formed of a plastic material. For example, the fifth lens 450 may be formed of a plastic material having optical properties (refractive index and Abbe number) different from those of the fourth lens 440. An Abbe number of the fifth lens 450 may be 50 or more. The fifth lens 450 may be configured as an aspherical lens. For example, an object-side surface and an image-side surface of the fifth lens 450 may be aspherical.

A focal length of the optical imaging system 400 according to the fourth embodiment may be 2.927 mm, a Fno may be 2.282, a FOV may be 85.479°, and a TTL may be 3.060 mm.

Table 7 below lists optical and physical parameters of the optical imaging system 400 according to the fourth embodiment.

TABLE 7

| | Radius of | Thickness/ | Refractive | Abbe | Focal | Effective |
|---|---|---|---|---|---|---|
| Surface | Curvature | Distance | Index | number | length | Radius |
| Object | Infinity | Infinity | | | | |
| 1 | Infinity | −0.251 | | | | |
| 2 | 0.872 | 0.409 | 1.544 | 56.00 | 2.317 | 0.641 |
| 3 | 2.339 | 0.077 | | | | 0.584 |
| 4 | −72.247 | 0.151 | 1.671 | 19.40 | −6.445 | 0.562 |
| 5 | 4.661 | 0.090 | | | | 0.504 |
| 6 | Infinity | 0.067 | | | | |
| 7 | 10.235 | 0.176 | 1.671 | 19.40 | 23.722 | 0.579 |
| 8 | 27.889 | 0.420 | | | | 0.718 |
| 9 | −21.922 | 0.210 | 1.567 | 37.40 | 26.285 | 0.981 |
| 10 | −8.938 | 0.234 | | | | 1.166 |
| 11 | 1.564 | 0.383 | 1.535 | 55.70 | −5.724 | 1.813 |
| 12 | 0.948 | 0.224 | | | | 1.972 |
| 13 | Infinity | 0.110 | 1.517 | 64.20 | | |
| 14 | Infinity | 0.509 | | | | |
| Image | Infinity | | | | | |

Table 8 below lists aspherical data of the optical imaging system 400 according to the fourth embodiment.

TABLE 8

| Surface | 2 | 3 | 4 | 5 | 7 |
|---|---|---|---|---|---|
| K | −7.57E−02 | 9.78E+00 | 0.00E+00 | 1.46E+00 | 0.00E+00 |
| A | −3.23E−01 | −5.77E−01 | 3.67E−01 | −2.50E−01 | −7.31E−01 |
| B | 1.52E+01 | 1.75E+01 | −4.48E+01 | 1.17E+01 | 1.08E+01 |
| C | −4.32E+02 | −7.40E+02 | 1.99E+03 | −2.93E+02 | −3.74E+02 |
| D | 8.20E+03 | 2.04E+04 | −5.53E+04 | 6.29E+03 | 8.34E+03 |
| E | −1.07E+05 | −3.77E+05 | 1.04E+06 | −1.19E+05 | −1.25E+05 |
| F | 9.86E+05 | 4.82E+06 | −1.38E+07 | 2.09E+06 | 1.33E+06 |
| G | −6.52E+06 | −4.34E+07 | 1.31E+08 | −2.97E+07 | −1.03E+07 |
| H | 3.13E+07 | 2.79E+08 | −8.99E+08 | 3.11E+08 | 5.98E+07 |
| J | −1.09E+08 | −1.28E+09 | 4.48E+09 | −2.29E+09 | −2.57E+08 |
| L | 2.70E+08 | 4.18E+09 | −1.60E+10 | 1.18E+10 | 8.03E+08 |
| M | −4.69E+08 | −9.41E+09 | 3.98E+10 | −4.09E+10 | −1.78E+09 |
| N | 5.38E+08 | 1.39E+10 | −6.57E+10 | 9.21E+10 | 2.62E+09 |
| O | −3.67E+08 | −1.22E+10 | 6.45E+10 | −1.21E+11 | −2.30E+09 |
| P | 1.12E+08 | 4.77E+09 | −2.85E+10 | 7.04E+10 | 9.12E+08 |
| Surface | 8 | 9 | 10 | 11 | 12 |
| K | 0.00E+00 | 0.00E+00 | 0.00E+00 | −9.00E−01 | −2.62E+00 |
| A | −3.76E−01 | −4.65E−01 | −1.14E+00 | −1.89E+00 | −1.17E+00 |
| B | −2.47E+00 | 3.78E−01 | 7.70E+00 | 4.42E+00 | 2.70E+00 |
| C | 4.35E+01 | 4.10E+01 | −5.06E+01 | −9.11E+00 | −5.04E+00 |
| D | −3.29E+02 | −6.51 E+02 | 2.76E+02 | 1.52E+01 | 7.22E+00 |
| E | −2.70E+02 | 5.17E+03 | −1.13E+03 | −1.86E+01 | −7.83E+00 |
| F | 3.03E+04 | −2.58E+04 | 3.35E+03 | 1.63E+01 | 6.42E+00 |
| G | −3.16E+05 | 8.70E+04 | −7.08E+03 | −1.04E+01 | −3.96E+00 |
| H | 1.84E+06 | −2.03E+05 | 1.07E+04 | 4.88E+00 | 1.84E+00 |
| J | −6.96E+06 | 3.31E+05 | −1.16E+04 | −1.68E+00 | −6.34E−01 |
| L | 1.78E+07 | −3.76E+05 | 8.87E+03 | 4.21E−01 | 1.59E−01 |
| M | −3.08E+07 | 2.89E+05 | −4.67E+03 | −7.46E−02 | −2.83E−02 |
| N | 3.44E+07 | −1.44E+05 | 1.61E+03 | 8.83E−03 | 3.35E−03 |
| O | −2.24E+07 | 4.17E+04 | −3.25E+02 | −6.28E−04 | −2.37E−04 |
| P | 6.47E+06 | −5.32E+03 | 2.93E+01 | 2.02E−05 | 7.58E−06 |

### Fifth Embodiment

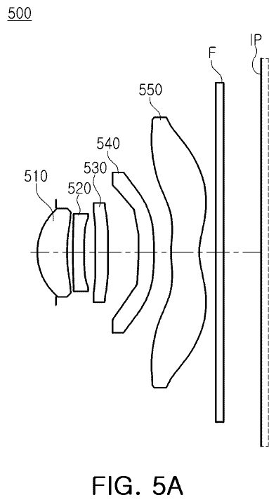

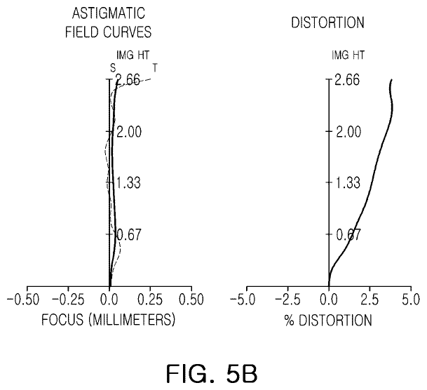

FIG. 5A is a configuration diagram illustrating an optical imaging system according to a fifth embodiment. FIG. 5B is a graph indicating aberration properties of an optical imaging system according to the fifth embodiment.

According to the fifth embodiment, an optical imaging system 500 may include a first lens 510, a second lens 520, a third lens 530, a fourth lens 540, and a fifth lens 550 disposed in order from an object side, and may further include an infrared blocking filter F and an image sensor IP disposed on an image side of the fifth lens 550.

Also, a stop may be disposed between an object-side surface and an image-side surface of the first lens 510, and a spacer may be disposed between the second lens 520 and the third lens 530.

The first lens 510 may have positive refractive power. A focal length of the first lens 510 may be 2.0 mm or more. An object-side surface of the first lens 510 may be convex in a paraxial region, and an image-side surface of the first lens 510 may be concave in a paraxial region. The first lens 510 may be formed of a plastic material. An Abbe number of the first lens 510 may be 50 or more. The first lens 510 may be configured as an aspherical lens. For example, an object-side surface and an image-side surface of the first lens 510 may be aspherical.

The second lens 520 may have negative refractive power. A focal length of the second lens 520 may be −6.0 mm or less. An object-side surface and an image-side surface of the second lens 520 may be concave in a paraxial region. The second lens 520 may be formed of a plastic material. For example, the second lens 520 may be formed of a plastic material having optical properties (refractive index and Abbe number) different from those of the first lens 510. An Abbe number of the second lens 520 may be less than 20. The second lens 520 may be configured as an aspherical lens. For example, an object-side surface and an image-side surface of the second lens 520 may be aspherical.

The third lens 530 may have positive refractive power. A focal length of the third lens 530 may be 18.0 mm or more. An object-side surface of the third lens 530 may be convex in a paraxial region, and an image-side surface of the third lens 530 may be concave in a paraxial region. The third lens 530 may be formed of a plastic material. For example, the third lens 530 may be formed of a plastic material having the same optical properties (refractive index and Abbe number) as those of the second lens 520. An Abbe number of the third lens 530 may be less than 20. The third lens 530 may be configured as an aspherical lens. For example, an object-side surface and an image-side surface of the third lens 530 may be aspherical.

The fourth lens 540 may have positive refractive power. A focal length of the fourth lens 540 may be 10.0 mm or more. An object-side surface of the fourth lens 540 may be concave in a paraxial region, and an image-side surface of the fourth lens 540 may be convex in a paraxial region. The fourth lens 540 may be formed of a plastic material. For example, the fourth lens 540 may be formed of a plastic material having optical properties (refractive index and Abbe number) different from those of the third lens 530. An Abbe number of the fourth lens 540 may be 10 or more, and may be less than an Abbe number of the first lens 510. The fourth lens 540 may be configured as an aspherical lens. For example, an object-side surface and an image-side surface of the fourth lens 540 may be aspherical.

The fifth lens 550 may have negative refractive power. A focal length of the fifth lens 550 may be less than-1.0 mm. An object-side surface of the fifth lens 550 may be convex, and an image-side surface of the fifth lens 550 may be concave. The fifth lens 550 may be formed of a plastic material. For example, the fifth lens 550 may be formed of a plastic material having optical properties (refractive index and Abbe number) different from those of the fourth lens 540. An Abbe number of the fifth lens 550 may be 50 or more. The fifth lens 550 may be configured as an aspherical lens. For example, an object-side surface and an image-side surface of the fifth lens 550 may be aspherical.

A focal length of the optical imaging system 500 according to the fifth embodiment may be 2.927 mm, a Fno may be 2.289, a FOV may be 85.498°, and a TTL may be 3.050 mm.

Table 9 below lists optical and physical parameters of the optical imaging system 500 according to the fifth embodiment.

TABLE 9

| | Radius of | Thickness/ | Refractive | Abbe | Focal | Effective |
|---|---|---|---|---|---|---|
| Surface | Curvature | Distance | Index | number | length | Radius |
| Object | Infinity | Infinity | | | | |
| 1 | Infinity | −0.251 | | | | |
| 2 | 0.869 | 0.408 | 1.544 | 56.00 | 2.309 | 0.639 |
| 3 | 2.328 | 0.078 | | | | 0.584 |
| 4 | −61.781 | 0.152 | 1.671 | 19.40 | −6.222 | 0.562 |
| 5 | 4.539 | 0.087 | | | | 0.502 |
| 6 | Infinity | 0.064 | | | | |
| 7 | 7.325 | 0.172 | 1.671 | 19.40 | 21.029 | 0.599 |
| 8 | 14.901 | 0.452 | | | | 0.716 |
| 9 | −16.287 | 0.210 | 1.567 | 37.40 | 25.039 | 0.979 |
| 10 | −7.647 | 0.233 | | | | 1.159 |
| 11 | 1.594 | 0.384 | 1.535 | 55.70 | −5.504 | 1.831 |
| 12 | 0.948 | 0.223 | | | | 1.972 |
| 13 | Infinity | 0.110 | 1.517 | 64.20 | | |
| 14 | Infinity | 0.509 | | | | |
| Image | Infinity | | | | | |

Table 10 below lists aspherical data of the optical imaging system 500 according to the fifth embodiment.

TABLE 10

| Surface | 2 | 3 | 4 | 5 | 7 |
|---|---|---|---|---|---|
| K | −9.22E−02 | 9.70E+00 | 0.00E+00 | −4.14E+00 | 0.00E+00 |
| A | −4.54E−01 | −7.24E−01 | 5.61E−01 | −1.93E−01 | −7.70E−01 |
| B | 2.18E+01 | 2.80E+01 | −6.03E+01 | −1.40E+00 | 1.04E+01 |
| C | −6.47E+02 | −1.19E+03 | 2.62E+03 | 6.05E+02 | −3.49E+02 |
| D | 1.28E+04 | 3.24E+04 | −7.13E+04 | −2.98E+04 | 7.71E+03 |
| E | −1.72E+05 | −5.86E+05 | 1.32E+06 | 8.19E+05 | −1.14E+05 |
| F | 1.64E+06 | 7.32E+06 | −1.71E+07 | −1.45E+07 | 1.21E+06 |
| G | −1.12E+07 | −6.45E+07 | 1.60E+08 | 1.76E+08 | −9.39E+06 |
| H | 5.56E+07 | 4.05E+08 | −1.09E+09 | −1.52E+09 | 5.43E+07 |
| J | −2.00E+08 | −1.82E+09 | 5.37E+09 | 9.29E+09 | −2.34E+08 |
| L | 5.17E+08 | 5.83E+09 | −1.90E+10 | −4.04E+10 | 7.33E+08 |
| M | −9.34E+08 | −1.29E+10 | 4.70E+10 | 1.22E+11 | −1.63E+09 |
| N | 1.12E+09 | 1.88E+10 | −7.71E+10 | −2.43E+11 | 2.40E+09 |
| O | −7.98E+08 | −1.62E+10 | 7.53E+10 | 2.88E+11 | −2.11E+09 |
| P | 2.57E+08 | 6.24E+09 | −3.31E+10 | −1.53E+11 | 8.36E+08 |
| Surface | 8 | 9 | 10 | 11 | 12 |
| K | 0.00E+00 | 0.00E+00 | 0.00E+00 | −8.56E−01 | −2.65E+00 |
| A | −3.63E−01 | −5.18E−01 | −1.23E+00 | −1.92E+00 | −1.17E+00 |
| B | −4.23E+00 | 3.19E−01 | 8.61E+00 | 4.54E+00 | 2.73E+00 |
| C | 8.98E+01 | 4.80E+01 | −5.92E+01 | −9.46E+00 | −5.15E+00 |
| D | −1.04E+03 | −7.57E+02 | 3.32E+02 | 1.63E+01 | 7.53E+00 |
| E | 6.80E+03 | 6.07E+03 | −1.38E+03 | −2.06E+01 | −8.39E+00 |
| F | −1.75E+04 | −3.07E+04 | 4.12E+03 | 1.88E+01 | 7.08E+00 |
| G | −9.17E+04 | 1.05E+05 | −8.77E+03 | −1.25E+01 | −4.50E+00 |
| H | 1.11E+06 | −2.50E+05 | 1.34E+04 | 6.14E+00 | 2.14E+00 |
| J | −5.34E+06 | 4.16E+05 | −1.46E+04 | −2.20E+00 | −7.53E−01 |
| L | 1.55E+07 | −4.82E+05 | 1.13E+04 | 5.75E−01 | 1.93E−01 |
| M | −2.90E+07 | 3.79E+05 | −6.01E+03 | −1.06E−01 | −3.47E−02 |
| N | 3.41E+07 | −1.93E+05 | 2.09E+03 | 1.30E−02 | 4.16E−03 |
| O | −2.30E+07 | 5.74E+04 | −4.29E+02 | −9.63E−04 | −2.99E−04 |
| P | 6.85E+06 | −7.54E+03 | 3.91E+01 | 3.23E−05 | 9.67E−06 |

### Sixth Embodiment

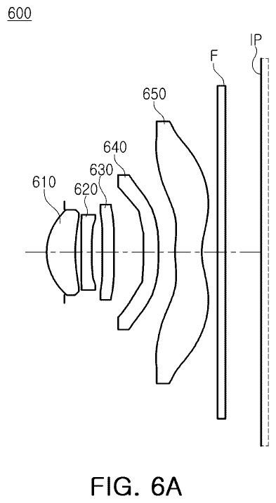

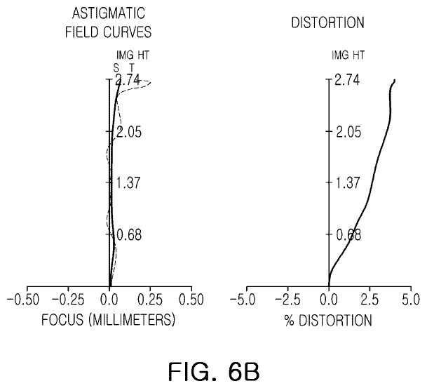

FIG. 6A is a configuration diagram illustrating an optical imaging system according to a sixth embodiment. FIG. 6B is a graph indicating aberration properties of an optical imaging system according to the sixth embodiment.

According to a sixth embodiment, an optical imaging system 600 may include a first lens 610, a second lens 620, a third lens 630, a fourth lens 640, and a fifth lens 650 disposed in order from an object side, and may further include an infrared blocking filter F and an image sensor IP disposed on an image side of the fifth lens 650.

Also, a stop may be disposed between an object-side surface and an image-side surface of the first lens 610, and a spacer may be disposed between the second lens 620 and the third lens 630.

The first lens 610 may have positive refractive power. A focal length of the first lens 610 may be 2.0 mm or more. An object-side surface of the first lens 610 may be convex in a paraxial region, and an image-side surface of the first lens 610 may be concave in a paraxial region. The first lens 610 may be formed of a plastic material. An Abbe number of the first lens 610 may be 50 or more. The first lens 610 may be configured as an aspherical lens. For example, an object-side surface and an image-side surface of the first lens 610 may be aspherical.

The second lens 620 may have negative refractive power. A focal length of the second lens 620 may be −6.0 mm or less. An object-side surface and an image-side surface of the second lens 620 may be concave in a paraxial region. The second lens 620 may be formed of a plastic material. For example, the second lens 620 may be formed of a plastic material having optical properties (refractive index and Abbe number) different from those of the first lens 610. An Abbe number of the second lens 620 may be less than 20. The second lens 620 may be configured as an aspherical lens. For example, an object-side surface and an image-side surface of the second lens 620 may be aspherical.

The third lens 630 may have positive refractive power. A focal length of the third lens 630 may be 18.0 mm or more. An object-side surface of the third lens 630 may be convex in a paraxial region, and an image-side surface of the third lens 630 may be concave in a paraxial region. The third lens 630 may be formed of a plastic material. For example, the third lens 630 may be formed of a plastic material having the same optical properties (refractive index and Abbe number) as those of the second lens 620. An Abbe number of the third lens 630 may be less than 20. The third lens 630 may be configured as an aspherical lens. For example, an object-side surface and an image-side surface of the third lens 630 may be aspherical.

The fourth lens 640 may have positive refractive power. A focal length of the fourth lens 640 may be 10.0 mm or more. An object-side surface of the fourth lens 640 may be concave in a paraxial region, and an image-side surface of the fourth lens 640 may be convex in a paraxial region. The fourth lens 640 may be formed of a plastic material. For example, the fourth lens 640 may be formed of a plastic material having optical properties (refractive index and Abbe number) different from those of the third lens 630. An Abbe number of the fourth lens 640 may be 10 or more, and may be less than an Abbe number of the first lens 610. The fourth lens 640 may be configured as an aspherical lens. For example, an object-side surface and an image-side surface of the fourth lens 640 may be aspherical.

The fifth lens 650 may have negative refractive power. A focal length of the fifth lens 650 may be less than-1.0 mm. An object-side surface of the fifth lens 650 may be convex, and an image-side surface of the fifth lens 650 may be concave. The fifth lens 650 may be formed of a plastic material. For example, the fifth lens 650 may be formed of a plastic material having optical properties (refractive index and Abbe number) different from those of the fourth lens 640. An Abbe number of the fifth lens 650 may be 50 or more. The fifth lens 650 may be configured as an aspherical lens. For example, an object-side surface and an image-side surface of the fifth lens 650 may be aspherical.

A focal length of the optical imaging system 600 according to the sixth embodiment may be 2.927 mm, a Fno may be 2.289, a FOV may be 85.499°, and a TTL may be 3.040 mm.

Table 11 below lists optical and physical parameters of the optical imaging system 600 according to the sixth embodiment.

TABLE 11

| | Radius of | Thickness/ | Refractive | Abbe | Focal | Effective |
|---|---|---|---|---|---|---|
| Surface | Curvature | Distance | Index | number | length | Radius |
| Object | Infinity | Infinity | | | | |
| 1 | Infinity | −0.259 | | | | |
| 2 | 0.868 | 0.407 | 1.544 | 56.00 | 2.306 | 0.639 |
| 3 | 2.328 | 0.078 | | | | 0.585 |
| 4 | −67.371 | 0.152 | 1.671 | 19.40 | −6.200 | 0.562 |
| 5 | 4.493 | 0.086 | | | | 0.503 |
| 6 | Infinity | 0.062 | | | | |
| 7 | 6.882 | 0.171 | 1.671 | 19.40 | 20.043 | 0.594 |
| 8 | 13.784 | 0.420 | | | | 0.711 |
| 9 | −16.025 | 0.210 | 1.567 | 37.40 | 23.501 | 0.980 |
| 10 | −7.336 | 0.235 | | | | 1.156 |
| 11 | 1.616 | 0.376 | 1.535 | 55.70 | −5.252 | 1.840 |
| 12 | 0.944 | 0.224 | | | | 1.960 |
| 13 | Infinity | 0.110 | 1.517 | 64.20 | | |
| 14 | Infinity | 0.508 | | | | |
| Image | Infinity | | | | | |

Table 12 below lists aspherical data of the optical imaging system 600 according to the sixth embodiment.

TABLE 12

| Surface | 2 | 3 | 4 | 5 | 7 |
|---|---|---|---|---|---|
| K | −9.90E−02 | 9.75E+00 | 0.00E+00 | −6.22E+00 | 0.00E+00 |
| A | −1.32E−01 | −6.48E−01 | 6.29E−01 | −2.11E−01 | −7.99E−01 |
| B | −1.74E+00 | 2.21E+01 | −6.96E+01 | 1.62E+01 | 1.11E+01 |
| C | 1.56E+02 | −9.93E+02 | 3.08E+03 | −1.06E+03 | −3.71E+02 |
| D | −3.29E+03 | 2.83E+04 | −8.42E+04 | 4.42E+04 | 8.20E+03 |
| E | 3.50E+04 | −5.31E+05 | 1.55E+06 | −1.15E+06 | −1.22E+05 |
| F | −1.94E+05 | 6.79E+06 | −2.01E+07 | 1.99E+07 | 1.30E+06 |
| G | 2.64E+05 | −6.07E+07 | 1.87E+08 | −2.42E+08 | −1.02E+07 |
| H | 4.01E+06 | 3.85E+08 | −1.26E+09 | 2.09E+09 | 5.96E+07 |
| J | −3.28E+07 | −1.75E+09 | 6.16E+09 | −1.30E+10 | −2.58E+08 |
| L | 1.29E+08 | 5.59E+09 | −2.17E+10 | 5.75E+10 | 8.10E+09 |
| M | −3.07E+08 | −1.24E+10 | 5.33E+10 | −1.77E+11 | −1.80E+09 |
| N | 4.49E+08 | 1.80E+10 | −8.70E+10 | 3.59E+11 | 2.65E+09 |
| O | −3.73E+08 | −1.55E+10 | 8.45E+10 | −4.33E+11 | −2.32E+09 |
| P | 1.35E+08 | 5.95E+09 | −3.70E+10 | 2.35E+11 | 9.14E+08 |
| Surface | 8 | 9 | 10 | 11 | 12 |
| K | 0.00E+00 | 0.00E+00 | 0.00E+00 | −8.35E−01 | −2.62E+00 |
| A | −1.76E−01 | −5.22E−01 | −1.22E+00 | −1.93E+00 | −1.20E+00 |
| B | −1.51E+01 | 4.65E−02 | 7.84E+00 | 4.55E+00 | 2.82E+00 |
| C | 3.78E+02 | 5.20E+01 | −4.82E+01 | −9.55E+00 | −5.43E+00 |
| D | −5.54E+03 | −8.05E+02 | 2.54E+02 | 1.66E+01 | 8.11E+00 |
| E | 5.25E+04 | 6.48E+03 | −1.04E+03 | −2.15E+01 | −9.23E+00 |
| F | −3.37E+05 | −3.31E+04 | 3.08E+03 | 2.01E+01 | 7.94E+00 |
| G | 1.50E+06 | 1.14E+05 | −6.59E+03 | −1.37E+01 | −5.14E+00 |
| H | −4.59E+06 | −2.74E+05 | 1.01E+04 | 6.86E+00 | 2.49E+00 |
| J | 9.51E+06 | 4.60E+05 | −1.09E+04 | −2.53E+00 | −8.90E−01 |
| L | −1.23E+07 | −5.39E+05 | 8.34E+03 | 6.77E−01 | 2.31E−01 |
| M | 7.62E+06 | 4.29E+05 | −4.34E+03 | −1.28E−01 | −4.23E−02 |
| N | 2.02E+06 | −2.22E+05 | 1.47E+03 | 1.62E−02 | 5.16E−03 |
| O | −6.26E+06 | 6.68E+04 | −2.90E+02 | −1.24E−03 | −3.75E−04 |
| P | 2.87E+06 | −8.91E+03 | 2.50E+01 | 4.27E−05 | 1.23E−05 |

### Seventh Embodiment

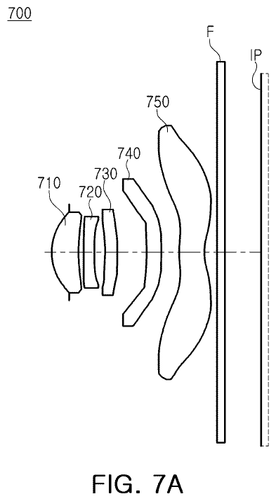

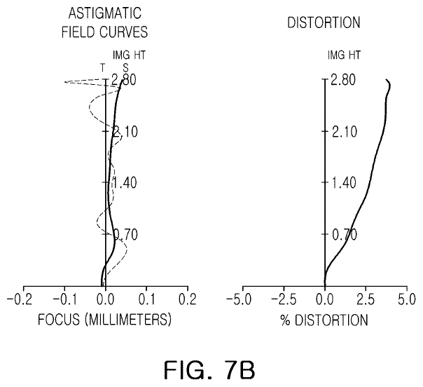

FIG. 7A is a configuration diagram illustrating an optical imaging system according to a seventh embodiment. FIG. 7B is a graph indicating aberration properties of an optical imaging system according to the seventh embodiment.

According to the seventh embodiment, an optical imaging system 700 may include a first lens 710, a second lens 720, a third lens 730, a fourth lens 740, and a fifth lens 750 disposed in order from an object side, and may further include an infrared blocking filter F and an image sensor IP disposed on an image side of the fifth lens 750.

Also, a stop may be disposed between an object-side surface and an image-side surface of the first lens 710, and a spacer may be disposed between the second lens 720 and the third lens 730.

The first lens 710 may have positive refractive power. A focal length of the first lens 710 may be 2.0 mm or more. An object-side surface of the first lens 710 may be convex in a paraxial region, and an image-side surface of the first lens 710 may be concave in a paraxial region. The first lens 710 may be formed of a plastic material. An Abbe number of the first lens 710 may be 50 or more. The first lens 710 may be configured as an aspherical lens. For example, an object-side surface and an image-side surface of the first lens 710 may be aspherical.

The second lens 720 may have negative refractive power. A focal length of the second lens 720 may be −6.0 mm or less. An object-side surface and an image-side surface of the second lens 720 may be concave in a paraxial region. The second lens 720 may be formed of a plastic material. For example, the second lens 720 may be formed of a plastic material having optical properties (refractive index and Abbe number) different from those of the first lens 710. An Abbe number of the second lens 720 may be less than 20. The second lens 720 may be configured as an aspherical lens. For example, an object-side surface and an image-side surface of the second lens 720 may be aspherical.

The third lens 730 may have positive refractive power. A focal length of the third lens 730 may be 18.0 mm or more. An object-side surface and an image-side surface of the third lens 730 may be convex in a paraxial region. The third lens 730 may be formed of a plastic material. For example, the third lens 730 may be formed of a plastic material having the same optical properties (refractive index and Abbe number) as those of the second lens 720. An Abbe number of the third lens 730 may be less than 20. The third lens 730 may be configured as an aspherical lens. For example, an object-side surface and an image-side surface of the third lens 730 may be aspherical.

The fourth lens 740 may have positive refractive power. A focal length of the fourth lens 740 may be 10.0 mm or more. An object-side surface of the fourth lens 740 may be concave in a paraxial region, and an image-side surface of the fourth lens 740 may be convex in a paraxial region. The fourth lens 740 may be formed of a plastic material. For example, the fourth lens 740 may be formed of a plastic material having optical properties (refractive index and Abbe number) different from those of the third lens 730. An Abbe number of the fourth lens 740 may be 10 or more, and may be less than an Abbe number of the first lens 710. The fourth lens 740 may be configured as an aspherical lens. For example, an object-side surface and an image-side surface of the fourth lens 740 may be aspherical.

The fifth lens 750 may have negative refractive power. A focal length of the fifth lens 750 may be less than-1.0 mm. An object-side surface of the fifth lens 750 may be convex, and an image-side surface of the fifth lens 750 may be concave. The fifth lens 750 may be formed of a plastic material. For example, the fifth lens 750 may be formed of a plastic material having optical properties (refractive index and Abbe number) different from those of the fourth lens 740. An Abbe number of the fifth lens 750 may be 50 or more. The fifth lens 750 may be configured as an aspherical lens. For example, an object-side surface and an image-side surface of the fifth lens 750 may be aspherical.

The optical imaging system 700 according to the seventh embodiment may have a focal length of 2.915 mm, an Fno of 2.289, an FOV of 85.496°, and a TTL of 3.090 mm.

Table 13 below lists optical and physical parameters of the optical imaging system 700 according to the seventh embodiment.

TABLE 13

| | Radius of | Thickness/ | Refractive | Abbe | Focal | Effective |
|---|---|---|---|---|---|---|
| Surface | Curvature | Distance | Index | number | length | Radius |
| Object | Infinity | Infinity | | | | |
| 1 | Infinity | −0.255 | | | | |
| 2 | 0.887 | 0.396 | 1.544 | 56.00 | 2.322 | 0.637 |
| 3 | 2.479 | 0.073 | | | | 0.589 |
| 4 | −577.991 | 0.162 | 1.671 | 19.40 | −6.861 | 0.566 |
| 5 | 4.696 | 0.086 | | | | 0.502 |
| 6 | Infinity | 0.074 | | | | |
| 7 | 24.929 | 0.180 | 1.671 | 19.40 | 29.931 | 0.550 |
| 8 | −109.584 | 0.435 | | | | 0.677 |
| 9 | −78.663 | 0.214 | 1.567 | 37.40 | 18.480 | 0.974 |
| 10 | −9.310 | 0.262 | | | | 1.159 |
| 11 | 1.661 | 0.376 | 1.535 | 55.70 | −5.147 | 1.865 |
| 12 | 0.955 | 0.182 | | | | 1.993 |
| 13 | Infinity | 0.110 | 1.517 | 64.20 | | |
| 14 | Infinity | 0.539 | | | | |
| Image | Infinity | | | | | |

Table 14 below lists aspherical data of the optical imaging system 700 according to the seventh embodiment.

TABLE 14

| Surface | 2 | 3 | 4 | 5 | 7 |
|---|---|---|---|---|---|
| K | −1.64E−01 | 1.01E+01 | 0.00E+00 | 7.22E−02 | 0.00E+00 |
| A | −2.35E−01 | −5.38E−01 | −5.22E−01 | −7.80E−01 | −8.34E−01 |
| B | 1.45E+01 | 1.81E+01 | 3.07E+01 | 5.32E+01 | 1.26E+01 |
| C | −4.60E+02 | −8.85E+02 | −1.35E+03 | −1.93E+03 | −3.41 E+02 |
| D | 9.20E+03 | 2.51E+04 | 3.61E+04 | 4.41E+04 | 4.36E+03 |
| E | −1.23E+05 | −4.56E+05 | −6.22E+05 | −6.32E+05 | −2.49E+03 |
| F | 1.14E+06 | 5.63E+06 | 7.33E+06 | 5.44E+06 | −7.75E+05 |
| G | −7.51E+06 | −4.87E+07 | −6.09E+07 | −2.04E+07 | 1.30E+07 |
| H | 3.59E+07 | 3.00E+08 | 3.62E+08 | −1.04E+08 | −1.17E+08 |
| J | −1.25E+08 | −1.32E+09 | −1.54E+09 | 1.92E+09 | 6.76E+08 |
| L | 3.11E+08 | 4.14E+09 | 4.61E+09 | −1.26E+10 | −2.64E+09 |
| M | −5.46E+08 | −8.95E+09 | −9.49E+09 | 4.83E+10 | 6.95E+09 |
| N | 6.37E+08 | 1.27E+10 | 1.27E+10 | −1.12E+11 | −1.18E+10 |
| O | −4.45E+08 | −1.07E+10 | −9.74E+09 | 1.48E+11 | 1.18E+10 |
| P | 1.41E+08 | 4.03E+09 | 3.23E+09 | −8.52E+10 | −5.22E+09 |
| Surface | 8 | 9 | 10 | 11 | 12 |
| K | 0.00E+00 | 0.00E+00 | 0.00E+00 | −8.96E−01 | −2.82E+00 |
| A | −6.57E−02 | −4.84E−01 | −1.18E+00 | −1.78E+00 | −1.13E+00 |
| B | −1.92E+01 | −1.39E+00 | 8.78E+00 | 3.69E+00 | 2.56E+00 |
| C | 4.93E+02 | 6.92E+01 | −7.16E+01 | −6.42E+00 | −4.64E+00 |
| D | −7.96E+03 | −9.46E+02 | 4.58E+02 | 9.27E+00 | 6.45E+00 |
| E | 8.67E+04 | 7.30E+03 | −2.07E+03 | −9.95E+00 | −6.76E+00 |
| F | −6.63E+05 | −3.65E+04 | 6.50E+03 | 7.64E+00 | 5.32E+00 |
| G | 3.64E+06 | 1.25E+05 | −1.44E+04 | −4.17E+00 | −3.14E+00 |
| H | −1.45E+07 | −2.98E+05 | 2.27E+04 | 1.62E+00 | 1.39E+00 |
| J | 4.21E+07 | 5.00E+05 | −2.55E+04 | −4.37E−01 | −4.64E−01 |
| L | −8.78E+07 | −5.86E+05 | 2.02E+04 | 7.83E−02 | 1.14E−01 |
| M | 1.28E+08 | 4.68E+05 | −1.11E+04 | −8.10E−03 | −2.01E−02 |
| N | −1.25E+08 | −2.43E+05 | 3.99E+03 | 2.42E−04 | 2.43E−03 |
| O | 7.23E+07 | 7.40E+04 | −8.47E+02 | 3.68E−05 | −1.79E−04 |
| P | −1.90E+07 | −9.98E+03 | 8.05E+01 | −3.05E−06 | 6.07E−06 |

### Eighth Embodiment

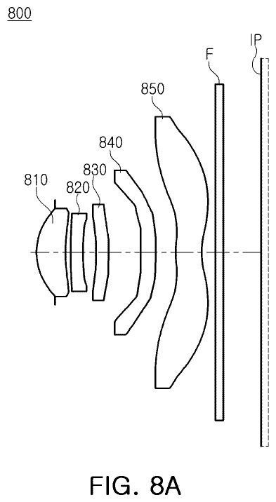

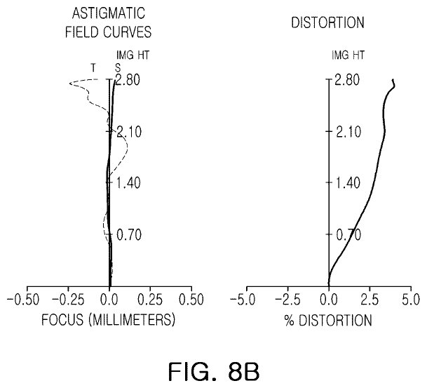

FIG. 8A is a configuration diagram illustrating an optical imaging system according to an eighth embodiment. FIG. 8B is a graph indicating aberration properties of an optical imaging system according to the eighth embodiment.

According to the eighth embodiment, an optical imaging system 800 may include a first lens 810, a second lens 820, a third lens 830, a fourth lens 840, and a fifth lens 850 disposed in order from an object side, and may further include an infrared blocking filter F and an image sensor IP disposed on an image side of the fifth lens 850.

Also, a stop may be disposed between an object-side surface and an image-side surface of the first lens 810, and a spacer may be disposed between the second lens 820 and the third lens 830.

The first lens 810 may have positive refractive power. A focal length of the first lens 810 may be 2.0 mm or more. An object-side surface of the first lens 810 may be convex in a paraxial region, and an image-side surface of the first lens 810 may be concave in a paraxial region. The first lens 810 may be formed of a plastic material. An Abbe number of the first lens 810 may be 50 or more. The first lens 810 may be configured as an aspherical lens. For example, an object-side surface and an image-side surface of the first lens 810 may be aspherical.

The second lens 820 may have negative refractive power. A focal length of the second lens 820 may be −6.0 mm or less. An object-side surface of the second lens 820 may be convex in a paraxial region, and an image-side surface of the second lens 820 may be concave in a paraxial region. The second lens 820 may be formed of a plastic material. For example, the second lens 820 may be formed of a plastic material having optical properties (refractive index and Abbe number) different from those of the first lens 810. An Abbe number of the second lens 820 may be less than 20. The second lens 820 may be configured as an aspherical lens. For example, an object-side surface and an image-side surface of the second lens 820 may be aspherical.

The third lens 830 may have positive refractive power. A focal length of the third lens 830 may be 18.0 mm or more. An object-side surface of the third lens 830 may be convex in a paraxial region, and an image-side surface of the third lens 830 may be concave in a paraxial region. The third lens 830 may be formed of a plastic material. For example, the third lens 830 may be formed of a plastic material having the same optical properties (refractive index and Abbe number) as those of the second lens 820. An Abbe number of the third lens 830 may be less than 20. The third lens 830 may be configured as an aspherical lens. For example, an object-side surface and an image-side surface of the third lens 830 may be aspherical.

The fourth lens 840 may have positive refractive power. A focal length of the fourth lens 840 may be 10.0 mm or more. An object-side surface and an image-side surface of the fourth lens 840 may be convex in a paraxial region. The fourth lens 840 may be formed of a plastic material. For example, the fourth lens 840 may be formed of a plastic material having optical properties (refractive index and Abbe number) different from those of the third lens 830. An Abbe number of the fourth lens 840 may be 10 or more, and may be less than an Abbe number of the first lens 810. The fourth lens 840 may be configured as an aspherical lens. For example, an object-side surface and an image-side surface of the fourth lens 840 may be aspherical.

The fifth lens 850 may have negative refractive power. A focal length of the fifth lens 850 may be less than-1.0 mm. An object-side surface of the fifth lens 850 may be convex, and an image-side surface of the fifth lens 850 may be concave. The fifth lens 850 may be formed of a plastic material. For example, the fifth lens 850 may be formed of a plastic material having optical properties (refractive index and Abbe number) different from those of the fourth lens 840. An Abbe number of the fifth lens 850 may be 50 or more. The fifth lens 850 may be configured as an aspherical lens. For example, an object-side surface and an image-side surface of the fifth lens 850 may be aspherical.

The optical imaging system 800 according to the eighth embodiment may have a focal length of 2.927 mm, an Fno of 2.290, an FOV of 85.488°, and a TTL of 3.060 mm.

Table 15 below lists optical and physical parameters of the optical imaging system 800 according to the eighth embodiment.

TABLE 15

| | Radius of | Thickness/ | Refractive | Abbe | Focal | Effective |
|---|---|---|---|---|---|---|
| Surface | Curvature | Distance | Index | number | length | Radius |
| Object | Infinity | Infinity | | | | |
| 1 | Infinity | −0.255 | | | | |
| 2 | 0.893 | 0.397 | 1.544 | 56.00 | 2.341 | 0.639 |
| 3 | 2.492 | 0.068 | | | | 0.593 |
| 4 | 26.971 | 0.170 | 1.671 | 19.40 | −7.005 | 0.570 |
| 5 | 4.033 | 0.094 | | | | 0.501 |
| 6 | Infinity | 0.081 | | | | |
| 7 | 18.351 | 0.175 | 1.671 | 19.40 | 34.958 | 0.568 |
| 8 | 80.610 | 0.435 | | | | 0.693 |
| 9 | 14.860 | 0.210 | 1.567 | 37.40 | 12.650 | 1.014 |
| 10 | −13.971 | 0.273 | | | | 1.193 |
| 11 | 1.811 | 0.352 | 1.535 | 55.70 | −4.399 | 1.828 |
| 12 | 0.955 | 0.182 | | | | 1.973 |
| 13 | Infinity | 0.110 | 1.517 | 64.20 | | |
| 14 | Infinity | 0.514 | | | | |
| Image | Infinity | | | | | |

Table 16 below lists aspherical data of the optical imaging system 800 according to the eighth embodiment.

TABLE 16

| Surface | 2 | 3 | 4 | 5 | 7 |
|---|---|---|---|---|---|
| K | −1.70E−01 | 9.60E+00 | 0.00E+00 | −4.32E+00 | 0.00E+00 |
| A | 2.92E−01 | −3.69E−01 | −3.99E−01 | −2.23E−01 | −8.55E−01 |
| B | −2.46E+01 | 8.43E+00 | 1.88E+01 | −1.76E+01 | 1.08E+01 |
| C | 8.86E+02 | −5.45E+02 | −7.89E+02 | 2.18E+03 | −4.32E+02 |
| D | −1.80E+04 | 1.66E+04 | 1.85E+04 | −9.51E+04 | 1.22E+04 |
| E | 2.36E+05 | −3.09E+05 | −2.61E+05 | 2.40E+06 | −2.35E+05 |
| F | −2.13E+06 | 3.79E+06 | 2.34E+06 | −3.97E+07 | 3.13E+06 |
| G | 1.37E+07 | −3.23E+07 | −1.30E+07 | 4.52E+08 | −2.97E+07 |
| H | −6.34E+07 | 1.94E+08 | 3.878E+07 | −3.65E+09 | 2.02E+08 |
| J | 2.13E+08 | −8.27E+08 | 1.96E+07 | 2.10E+10 | −9.87E+08 |
| L | −5.16E+08 | 2.50E+09 | −6.58E+08 | −8.59E+10 | 3.43E+09 |
| M | 8.72E+08 | −5.19E+09 | 2.79E+09 | 2.44E+11 | −8.26E+09 |
| N | −9.77E+08 | 7.10E+09 | −6.07E+09 | −4.57E+11 | 1.31E+10 |
| O | 6.52E+08 | −5.72E+09 | 7.07E+09 | 5.07E+11 | −1.23E+10 |
| P | −1.96E+08 | 2.06E+09 | −3.49E+09 | −2.53E+11 | 5.15E+09 |
| Surface | 8 | 9 | 10 | 11 | 12 |
| K | 0.00E+00 | 0.00E+00 | 0.00E+00 | −8.05E−01 | −3.33E+00 |
| A | −4.13E−01 | −4.11E−01 | −9.86E−01 | −1.86E+00 | −1.21E+00 |
| B | −1.09E+01 | −2.11E+00 | 6.58E+00 | 4.28E+00 | 3.16E+00 |
| C | 3.73E+02 | 6.91E+01 | −4.95E+01 | −8.55E+00 | −6.68E+00 |
| D | −7.00E+03 | −8.81E+02 | 3.01E+02 | 1.53E+01 | 1.08E+01 |
| E | 8.36E+04 | 6.61E+03 | −1.30E+03 | −2.15E+01 | −1.31E+01 |
| F | −6.74E+05 | −3.25E+04 | 3.88E+03 | 2.20E+01 | 1.17E+01 |
| G | 3.80E+06 | 1.09E+05 | −8.19E+03 | −1.62E+01 | −7.80E+00 |
| H | −1.53E+07 | −2.55E+05 | 1.23E+04 | 8.68E+00 | 3.84E+00 |
| J | 4.38E+07 | 4.20E+05 | −1.32E+04 | −3.36E+00 | −1.39E+00 |
| L | −8.95E+07 | −4.84E+05 | 1.01E+04 | 9.26E−01 | 3.62E−01 |
| M | 1.27E+08 | 3.81E+05 | −5.29E+03 | −1.78E−01 | −6.65E−02 |
| N | −1.18E+08 | −1.95E+05 | 1.82E+03 | 2.25E−02 | 8.12E−03 |
| O | 6.49E+07 | 5.84E+04 | −3.70E+02 | −1.69E−03 | −5.93E−04 |
| P | −1.60E+07 | −7.79E+03 | 3.36E+01 | 5.68E−05 | 1.96E−05 |

### Ninth Embodiment

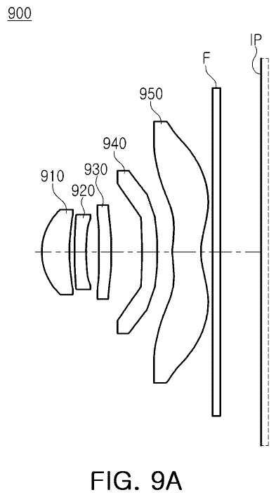

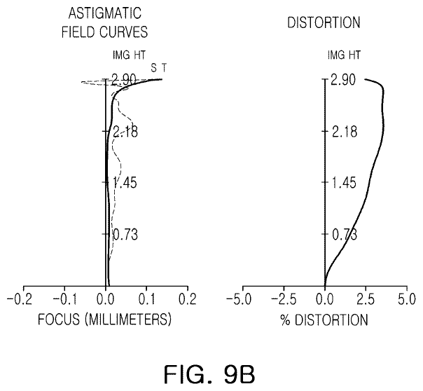

FIG. 9A is a configuration diagram illustrating an optical imaging system according to a ninth embodiment. FIG. 9B is a graph indicating aberration properties of an optical imaging system according to the ninth embodiment.

According to the ninth embodiment, an optical imaging system 900 may include a first lens 910, a second lens 920, a third lens 930, a fourth lens 940, and a fifth lens 950 disposed in order from an object side, and may further include an infrared blocking filter F and an image sensor IP disposed on an image side of the fifth lens 950.

Also, although not illustrated in the drawing, a stop may be disposed between an object-side surface and an image-side surface of the first lens 910, and a spacer may be disposed between the second lens 920 and the third lens 930.

The first lens 910 may have positive refractive power. A focal length of the first lens 910 may be 2.0 mm or more. An object-side surface of the first lens 910 may be convex in a paraxial region, and an image-side surface of the first lens 910 may be concave in a paraxial region. The first lens 910 may be formed of a plastic material. An Abbe number of the first lens 910 may be 50 or more. The first lens 910 may be configured as an aspherical lens. For example, an object-side surface and an image-side surface of the first lens 910 may be aspherical.

The second lens 920 may have negative refractive power. A focal length of the second lens 920 may be −6.0 mm or less. An object-side surface of the second lens 920 may be convex in a paraxial region, and an image-side surface of the second lens 920 may be concave in a paraxial region. The second lens 920 may be formed of a plastic material. For example, the second lens 920 may be formed of a plastic material having optical properties (refractive index and Abbe number) different from those of the first lens 910. An Abbe number of the second lens 920 may be less than 20. The second lens 920 may be configured as an aspherical lens. For example, an object-side surface and an image-side surface of the second lens 920 may be aspherical.

The third lens 930 may have positive refractive power. A focal length of the third lens 930 may be 18.0 mm or more. An object-side surface of the third lens 930 may be convex in a paraxial region, and an image-side surface of the third lens 930 may be concave in a paraxial region. The third lens 930 may be formed of a plastic material. For example, the third lens 930 may be formed of a plastic material having the same optical properties (refractive index and Abbe number) as those of the second lens 920. An Abbe number of the third lens 930 may be less than 20. The third lens 930 may be configured as an aspherical lens. For example, an object-side surface and an image-side surface of the third lens 930 may be aspherical.

The fourth lens 940 may have positive refractive power. A focal length of the fourth lens 940 may be 10.0 mm or more. An object-side surface of the fourth lens 940 may be concave in a paraxial region, and an image-side surface of the fourth lens 940 may be convex in a paraxial region. The fourth lens 940 may be formed of a plastic material. For example, the fourth lens 940 may be formed of a plastic material having optical properties (refractive index and Abbe number) different from those of the third lens 930. An Abbe number of the fourth lens 940 may be 10 or more, and may be less than an Abbe number of the first lens 910. The fourth lens 940 may be configured as an aspherical lens. For example, an object-side surface and an image-side surface of the fourth lens 940 may be aspherical.

The fifth lens 950 may have negative refractive power. A focal length of the fifth lens 950 may be less than-1.0 mm. An object-side surface of the fifth lens 950 may be convex, and an image-side surface of the fifth lens 950 may be concave. The fifth lens 950 may be formed of a plastic material. For example, the fifth lens 950 may be formed of a plastic material having optical properties (refractive index and Abbe number) different from those of the fourth lens 940. An Abbe number of the fifth lens 950 may be 50 or more. The fifth lens 950 may be configured as an aspherical lens. For example, an object-side surface and an image-side surface of the fifth lens 950 may be aspherical.

A focal length of the optical imaging system 900 according to the ninth embodiment may be 2.937 mm, a Fno may be 2.288, a FOV may be 85.487°, and a TTL may be 3.110 mm.

Table 17 below lists optical and physical parameters of the optical imaging system 900 according to the ninth embodiment.

TABLE 17

| | Radius of | Thickness/ | Refractive | Abbe | Focal | Effective |
|---|---|---|---|---|---|---|
| Surface | Curvature | Distance | Index | number | length | Radius |
| Object | Infinity | Infinity | | | | |
| 1 | Infinity | −0.259 | | | | |
| 2 | 0.910 | 0.394 | 1.544 | 56.00 | 2.333 | 0.642 |
| 3 | 2.696 | 0.072 | | | | 0.589 |
| 4 | 14.576 | 0.164 | 1.671 | 19.40 | −6.508 | 0.568 |
| 5 | 3.375 | 0.092 | | | | 0.503 |
| 6 | Infinity | 0.090 | | | | |
| 7 | 11.397 | 0.173 | 1.671 | 19.40 | 33.678 | 0.593 |
| 8 | 22.586 | 0.435 | | | | 0.711 |
| 9 | −39.751 | 0.223 | 1.567 | 37.40 | 45.933 | 1.029 |
| 10 | −15.830 | 0.210 | | | | 1.231 |
| 11 | 1.383 | 0.405 | 1.535 | 55.70 | −7.363 | 1.841 |
| 12 | 0.920 | 0.163 | | | | 1.972 |
| 13 | Infinity | 0.110 | 1.517 | 64.20 | | |
| 14 | Infinity | 0.578 | | | | |
| Image | Infinity | | | | | |

Table 18 below lists aspherical data of the optical imaging system 900 according to the ninth embodiment.

TABLE 18

| Surface | 2 | 3 | 4 | 5 | 7 |
|---|---|---|---|---|---|
| K | −8.92E−02 | 1.30E+01 | 0.00E+00 | −1.08E+01 | 0.00E+00 |
| A | 9.18E−02 | −4.77E−02 | −2.78E−01 | −4.86E−01 | 9.82E−02 |
| B | −7.22E+00 | −8.58E+00 | 4.87E+00 | 4.74E+01 | −3.75E+01 |
| C | 2.38E+02 | 1.74E+02 | −8.81E+01 | −2.25E+03 | 1.43E+03 |
| D | −4.32E+03 | −2.18E+03 | 5.79E+02 | 6.94E+04 | −3.43E+04 |
| E | 4.91E+04 | 1.79E+04 | 1.74E+04 | −1.43E+06 | 5.53E+05 |
| F | −3.64E+05 | −9.27E+04 | −4.90E+05 | 2.07E+07 | −6.20E+06 |
| G | 1.78E+06 | 2.44E+05 | 6.12E+06 | −2.12E+08 | 4.94E+07 |
| H | −5.53E+06 | 3.07E+05 | −4.71E+07 | 1.58E+09 | −2.83E+08 |
| J | 9.31E+06 | −5.87E+06 | 2.42E+08 | −8.45E+09 | 1.17E+09 |
| L | −5.52E+05 | 2.73E+07 | −8.46E+08 | 3.25E+10 | −3.48E+09 |
| M | −3.42E+07 | −7.36E+07 | 2.00E+09 | −8.71E+10 | 7.20E+09 |
| N | 7.47E+07 | 1.23E+08 | −3.07E+09 | 1.55E+11 | −9.86E+09 |
| O | −7.16E+07 | −1.20E+08 | 2.75E+09 | −1.64E+11 | 8.03E+09 |
| P | 2.72E+07 | 5.13E+07 | −1.09E+09 | 7.79E+10 | −2.95E+09 |
| Surface | 8 | 9 | 10 | 11 | 12 |
| K | 0.00E+00 | 0.00E+00 | 5.47E+01 | −1.01E+00 | −2.84E+00 |
| A | −5.17E−01 | −3.70E−01 | −1.18E+00 | −2.01E+00 | −1.10E+00 |
| B | 6.88E+00 | 2.06E+00 | 7.40E+00 | 4.97E+00 | 2.51E+00 |
| C | −2.06E+02 | −1.09E+00 | −4.00E+01 | −1.11E+01 | −4.70E+00 |
| D | 3.86E+03 | −1.14E+02 | 1.80E+02 | 1.98E+01 | 6.79E+00 |
| E | −4.73E+04 | 1.07E+03 | −6.14E+02 | −2.54E+01 | −7.56E+00 |
| F | 3.95E+05 | −5.33E+03 | 1.52E+03 | 2.30E+01 | 6.52E+00 |
| G | −2.32E+06 | 1.69E+04 | −2.67E+03 | −1.49E+01 | −4.35E+00 |
| H | 9.73E+06 | −3.60E+04 | 3.35E+03 | 7.04E+00 | 2.22E+00 |
| J | −2.93E+07 | 5.23E+04 | −2.99E+03 | −2.41 E+00 | −8.56E−01 |
| L | 6.25E+07 | −5.16E+04 | 1.87E+03 | 5.93E−01 | 2.43E−01 |
| M | −9.25E+07 | 3.38E+04 | −8.02E+02 | −1.02E−01 | −4.89E−02 |
| N | 9.03E+07 | −1.40E+04 | 2.33E+02 | 1.16E−02 | 6.58E−03 |
| O | −5.21E+07 | 3.25E+03 | −3.61E+01 | −7.89E−04 | −5.30E−04 |
| P | 1.35E+07 | −3.17E+02 | 2.57E+00 | 2.40E−05 | 1.93E−05 |

### Tenth Embodiment

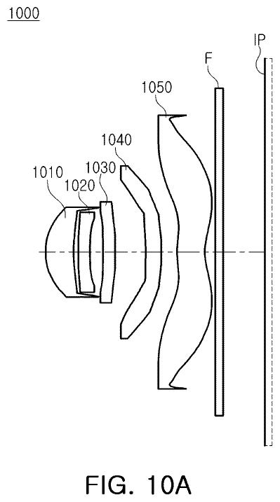

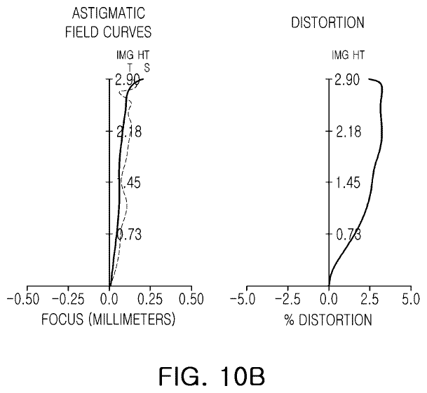

FIG. 10A is a configuration diagram illustrating an optical imaging system according to a tenth embodiment. FIG. 10B is a graph indicating aberration properties of an optical imaging system according to the tenth embodiment.

According to a tenth embodiment, an optical imaging system 1000 may include a first lens 1010, a second lens 1020, a third lens 1030, a fourth lens 1040, and a fifth lens 1050 disposed in order from an object side, and may further include an infrared blocking filter F and an image sensor IP disposed on an image side of the fifth lens 1050.

Also, although not illustrated in the drawing, a stop may be disposed between an object-side surface and an image-side surface of the first lens 1010, and a spacer may be disposed between the second lens 1020 and the third lens 1030.

The first lens 1010 may have positive refractive power. A focal length of the first lens 1010 may be 2.0 mm or more. An object-side surface of the first lens 1010 may be convex in a paraxial region, and an image-side surface of the first lens 1010 may be concave in a paraxial region. The first lens 1010 may be formed of a plastic material. An Abbe number of the first lens 1010 may be 50 or more. The first lens 1010 may be configured as an aspherical lens. For example, an object-side surface and an image-side surface of the first lens 1010 may be aspherical.

The second lens 1020 may have negative refractive power. A focal length of the second lens 1020 may be −6.0 mm or less. An object-side surface of the second lens 1020 may be convex in a paraxial region, and an image-side surface of the second lens 1020 may be concave in a paraxial region. The second lens 1020 may be formed of a plastic material. For example, the second lens 1020 may be formed of a plastic material having optical properties (refractive index and Abbe number) different from those of the first lens 1010. An Abbe number of the second lens 1020 may be less than 20. The second lens 1020 may be configured as an aspherical lens. For example, an object-side surface and an image-side surface of the second lens 1020 may be aspherical.

The third lens 1030 may have positive refractive power. A focal length of the third lens 1030 may be 18.0 mm or more. An object-side surface of the third lens 1030 may be convex in a paraxial region, and an image-side surface of the third lens 1030 may be concave in a paraxial region. The third lens 1030 may be formed of a plastic material. For example, the third lens 1030 may be formed of a plastic material having the same optical properties (refractive index and Abbe number) as those of the second lens 1020. An Abbe number of the third lens 1030 may be less than 20. The third lens 1030 may be configured as an aspherical lens. For example, an object-side surface and an image-side surface of the third lens 1030 may be aspherical.

The fourth lens 1040 may have positive refractive power. A focal length of the fourth lens 1040 may be 10.0 mm or more. An object-side surface of the fourth lens 1040 may be concave in a paraxial region, and an image-side surface of the fourth lens 1040 may be convex in a paraxial region. The fourth lens 1040 may be formed of a plastic material. For example, the fourth lens 1040 may be formed of a plastic material having optical properties (refractive index and Abbe number) different from those of the third lens 1030. An Abbe number of the fourth lens 1040 may be 10 or more, and may be less than an Abbe number of the first lens 1010. The fourth lens 1040 may be configured as an aspherical lens. For example, an object-side surface and an image-side surface of the fourth lens 1040 may be aspherical.

The fifth lens 1050 may have negative refractive power. A focal length of the fifth lens 1050 may be less than-1.0 mm. An object-side surface of the fifth lens 1050 may be convex, and an image-side surface of the fifth lens 1050 may be concave. The fifth lens 1050 may be formed of a plastic material. For example, the fifth lens 1050 may be formed of a plastic material having optical properties (refractive index and Abbe number) different from those of the fourth lens 1040. An Abbe number of the fifth lens 1050 may be 50 or more. The fifth lens 1050 may be configured as an aspherical lens. For example, an object-side surface and an image-side surface of the fifth lens 1050 may be aspherical.

A focal length of the optical imaging system 1000 according to the tenth embodiment may be 2.929 mm, a Fno may be 2.297, a FOV may be 85.100°, and a TTL may be 3.110 mm.

Table 19 below lists optical and physical parameters of the optical imaging system 1000 according to the tenth embodiment.

TABLE 19

| | Radius of | Thickness/ | Refractive | Abbe | Focal | Effective |
|---|---|---|---|---|---|---|
| Surface | Curvature | Distance | Index | number | length | Radius |
| Object | Infinity | Infinity | | | | |
| 1 | Infinity | −0.265 | | | | |
| 2 | 0.900 | 0.398 | 1.544 | 56.00 | 2.311 | 0.645 |
| 3 | 2.648 | 0.068 | | | | 0.594 |
| 4 | 15.741 | 0.163 | 1.671 | 19.40 | −6.443 | 0.573 |
| 5 | 3.408 | 0.094 | | | | 0.506 |
| 6 | Infinity | 0.090 | | | | |
| 7 | 12.009 | 0.173 | 1.671 | 19.40 | 29.563 | 0.603 |
| 8 | 29.724 | 0.435 | | | | 0.722 |
| 9 | −45.055 | 0.223 | 1.567 | 37.40 | 45.903 | 1.032 |
| 10 | −16.596 | 0.223 | | | | 1.238 |
| 11 | 1.415 | 0.392 | 1.535 | 55.70 | −6.660 | 1.833 |
| 12 | 0.916 | 0.147 | | | | 1.965 |
| 13 | Infinity | 0.110 | 1.517 | 64.20 | | |
| 14 | Infinity | 0.593 | | | | |
| Image | Infinity | | | | | |

Table 20 below lists aspherical data of the optical imaging system 1000 according to the tenth embodiment.

TABLE 20

| Surface | 2 | 3 | 4 | 5 | 7 |
|---|---|---|---|---|---|
| K | −1.25E−01 | 1.31E+01 | 0.00E+00 | −1.24E+01 | 0.00E+00 |
| A | −1.11E−01 | 1.50E−01 | −4.52E−01 | −1.44E+00 | −3.62E−01 |
| B | 6.93E+00 | −1.61E+01 | 1.54E+01 | 1.21E+02 | 1.51E+00 |
| C | −2.38E+02 | 2.42E+02 | −5.10E+02 | −5.52E+03 | −2.55E+02 |
| D | 5.01E+03 | −4.26E+02 | 1.12E+04 | 1.64E+05 | 9.38E+03 |
| E | −6.84E+04 | −4.57E+04 | −1.61E+05 | −3.28E+06 | −1.88E+05 |
| F | 6.37E+05 | 8.77E+05 | 1.60E+06 | 4.62E+07 | 2.40E+06 |
| G | −4.19E+06 | −8.87E+06 | −1.14E+07 | −4.66E+08 | −2.09E+07 |
| H | 1.98E+07 | 5.80E+07 | 5.91E+07 | 3.42E+09 | 1.27E+08 |
| J | −6.79E+07 | −2.61E+08 | −2.26E+08 | −1.82E+10 | −5.50E+08 |
| L | 1.66E+08 | 8.14E+08 | 6.30E+08 | 6.95E+10 | 1.67E+09 |
| M | −2.84E+08 | −1.74E+09 | −1.26E+09 | −1.86E+11 | −3.51E+09 |
| N | 3.20E+08 | 2.44E+09 | 1.70E+09 | 3.31E+11 | 4.83E+09 |
| O | −2.14E+08 | −2.02E+09 | −1.40E+09 | −3.50E+11 | −3.92E+09 |
| P | 6.43E+07 | 7.49E+08 | 5.29E+08 | 1.67E+11 | 1.42E+09 |
| Surface | 8 | 9 | 10 | 11 | 12 |
| K | 0.00E+00 | 0.00E+00 | 6.19E+01 | −1.00E+00 | −2.88E+00 |
| A | −4.74E−01 | −3.47E−01 | −1.08E+00 | −1.97E+00 | −1.11E+00 |
| B | 4.51E+00 | 9.88E−01 | 6.29E+00 | 4.85E+00 | 2.55E+00 |
| C | −1.27E+02 | 1.30E+01 | −3.04E+01 | −1.07E+01 | −4.70E+00 |
| D | 2.27E+03 | −2.31E+02 | 1.26E+02 | 1.90E+01 | 6.57E+00 |
| E | −2.67E+04 | 1.76E+03 | −4.11E+02 | −2.42E+01 | −6.94E+00 |
| F | 2.15E+05 | −8.25E+03 | 9.89E+02 | 2.18E+01 | 5.57E+00 |
| G | −1.23E+06 | 2.58E+04 | −1.70E+03 | −1.41 E+01 | −3.42E+00 |
| H | 5.04E+06 | −5.51E+04 | 2.08E+03 | 6.63E+00 | 1.60E+00 |
| J | −1.49E+07 | 8.18E+04 | −1.80E+03 | −2.27E+00 | −5.69E−01 |
| L | 3.13E+07 | −8.35E+04 | 1.08E+03 | 5.58E−01 | 1.50E−01 |
| M | −4.57E+07 | 5.75E+04 | −4.37E+02 | −9.63E−02 | −2.85E−02 |
| N | 4.41E+07 | −2.54E+04 | 1.13E+02 | 1.11E−02 | 3.67E−03 |
| O | −2.52E+07 | 6.48E+03 | −1.65E+01 | −7.59E−04 | −2.85E−04 |
| P | 6.45E+06 | −7.23E+02 | 1.01E+00 | 2.36E−05 | 1.01E−05 |

Table 21 below lists values of optical and physical parameters related to the conditional expressions of the optical imaging system according to embodiments.

TABLE 21

| | Embodiment 1 | Embodiment 2 | Embodiment 3 | Embodiment 4 | Embodiment 5 |
|---|---|---|---|---|---|
| f1/f2 | −0.364 | −0.314 | −0.340 | −0.360 | −0.371 |
| f1/f3 | 0.070 | −0.052 | −0.042 | 0.098 | 0.110 |
| f1/f | 0.797 | 0.751 | 0.761 | 0.792 | 0.789 |
| f2/f | −2.189 | −2.390 | −2.240 | −2.202 | −2.126 |
| \| f3/f \| | 11.412 | 14.325 | 18.152 | 8.104 | 7.184 |
| \| f4/f \| | 14.001 | 5.297 | 12.265 | 8.980 | 8.554 |
| f5/f | −2.588 | −25.644 | −3.117 | −1.955 | −1.880 |
| TTL/f | 1.066 | 1.087 | 1.076 | 1.045 | 1.042 |
| v1-v2 | 36.59 | 36.59 | 36.59 | 36.59 | 36.59 |
| v1-v4 | 18.59 | 34.49 | 18.59 | 18.59 | 18.59 |
| D1/f | 0.025 | 0.015 | 0.016 | 0.026 | 0.027 |
| ET1/SD1 | 0.287 | 0.285 | 0.285 | 0.281 | 0.282 |
| SD4/SD10 | 0.253 | 0.240 | 0.243 | 0.255 | 0.255 |
| CT2 | 0.162 | 0.180 | 0.180 | 0.151 | 0.152 |
| ET1 | 0.181 | 0.180 | 0.180 | 0.180 | 0.180 |
| | | | | | Embodiment |
| | Embodiment 6 | Embodiment 7 | Embodiment 8 | Embodiment 9 | 10 |
| f1/f2 | −0.372 | −0.338 | −0.334 | −0.358 | −0.359 |
| f1/f3 | 0.115 | 0.078 | 0.067 | 0.069 | 0.078 |
| f1/f | 0.788 | 0.797 | 0.800 | 0.794 | 0.789 |
| f2/f | −2.118 | −2.354 | −2.393 | −2.216 | −2.199 |
| \| f3/f \| | 6.847 | 10.268 | 11.944 | 11.468 | 10.092 |
| \| f4/f \| | 8.029 | 6.340 | 4.322 | 15.641 | 15.671 |
| f5/f | −1.764 | −1.766 | −1.503 | −2.507 | −2.274 |
| TTL/f | 1.039 | 1.060 | 1.045 | 1.059 | 1.062 |
| v1-v2 | 36.59 | 36.59 | 36.59 | 36.59 | 36.59 |
| v1-v4 | 18.59 | 18.59 | 18.59 | 18.59 | 18.59 |
| D1/f | 0.027 | 0.025 | 0.023 | 0.025 | 0.023 |
| ET1/SD1 | 0.281 | 0.283 | 0.281 | 0.281 | 0.279 |
| SD4/SD10 | 0.257 | 0.252 | 0.254 | 0.255 | 0.258 |
| CT2 | 0.152 | 0.162 | 0.170 | 0.164 | 0.163 |
| ET1 | 0.180 | 0.180 | 0.180 | 0.181 | 0.180 |

According to the aforementioned embodiments, the optical imaging system may be slimmed.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system, comprising:
a first lens, a second lens, a third lens, a fourth lens, and a fifth lens disposed in order from an object side,
wherein a conditional expression TTL/(2*IMG HT)≤0.57 is satisfied,
where TTL is a distance along an optical axis from an object-side surface of the first lens to an image plane, and IMG HT is half a diagonal length of the image plane.

2. The optical imaging system of claim 1, wherein a conditional expression-0.1<f1/f3<1.0 is satisfied,
where f1 is a focal length of the first lens, and f3 is a focal length of the third lens.

3. The optical imaging system of claim 1, wherein a conditional expression-0.6<f1/f2<0 is satisfied,
where f1 is a focal length of the first lens, and f2 is a focal length of the second lens.

4. The optical imaging system of claim 1, wherein an object-side surface of the second lens is concave.

5. The optical imaging system of claim 1, wherein a conditional expression 0<v1-v4<45 is satisfied,
where v1 is an Abbe number of the first lens, and v4 is an Abbe number of the fourth lens.

6. The optical imaging system of claim 1, wherein a conditional expression 70°<FOV* (2*IMG HT)/f is satisfied,
where FOV is a field of view of the optical imaging system, and f is a focal length of the optical imaging system.

7. The optical imaging system of claim 1, wherein an object-side surface of the fourth lens is convex.

8. The optical imaging system of claim 1, wherein an image-side surface of the third lens is convex.

9. The optical imaging system of claim 1, wherein a conditional expression Fno* {TTL/(2*IMG HT)}≤1.4 is satisfied.

10. An optical imaging system, comprising:
a first lens having positive refractive power;
a second lens having negative refractive power;
a third lens having refractive power;
a fourth lens having refractive power; and
a fifth lens having negative refractive power,
wherein the first lens to the fifth lens are disposed in order from an object side, wherein a conditional expression-0.1<f1/f3<1.0 is satisfied, and
where f1 is a focal length of the first lens, and f3 is a focal length of the third lens.

11. The optical imaging system of claim 10,
wherein an image-side surface of the first lens is concave, and
wherein a conditional expression D1/f<0.1 is satisfied,
where D1 is a distance between an image-side surface of the first lens and an object-side surface of the second lens, and f is a focal length of the optical imaging system.

12. The optical imaging system of claim 10, wherein an object-side surface of the second lens is concave.

13. The optical imaging system of claim 10, wherein a conditional expression 80°≤FOV is satisfied,
where FOV is a field of view of the optical imaging system.

14. The optical imaging system of claim 10, wherein a conditional expression TTL/(2*IMG HT)≤0.57 is satisfied,
where TTL is a distance from an object-side surface of the first lens to an image plane on an optical axis, and IMG HT is half a diagonal length of the image plane.

15. The optical imaging system of claim 10, wherein the third lens has negative refractive power and a concave object-side surface.

16. The optical imaging system of claim 10, wherein a conditional expression 3<|f4/f| is satisfied,
where f4 is a focal length of the fourth lens, and f is a focal length of the optical imaging system.
